(19) United States
(12) Patent Application Publication
(10) Pub. No.: US 2026/0024302 A1
(43) Pub. Date: Jan. 22, 2026

(54) PATH-BASED CONTOUR EXTRACTION FOR METROLOGY

(71) Applicant: FEI Company, Hillsboro, OR (US)

(72) Inventor: Brian Roberts Routh, JR., Beaverton, OR (US)

(21) Appl. No.: 18/777,093

(22) Filed: Jul. 18, 2024

(51) Int. Cl. G06V 10/46; G06T 5/20; G06T 7/13; G06T 11/60; G06V 10/764

(52) U.S. Cl. CPC G06V 10/46; G06T 5/20; G06T 7/13; G06T 11/60; G06V 10/764

(57) ABSTRACT

Embodiments described herein relate to a process for image contour line extraction. A system can comprise a memory that stores, and a processor that executes, computer executable components. The computer executable components can comprise an identifying component that identifies a contour line applied between regions of a pixelated image, and a subdividing component that subdivides the contour line into a set of barrier lines based on a parsing of contour line pixels of the contour line. In one or more embodiments, the parsing can be based on a quantity of neighbor pixels that are contiguous with the contour line pixels.

### BACKGROUND

Scientific instruments for use in material analysis can aid in determining the makeup and properties of an unknown composition. In one or more examples, a scientific instrument can provide structural makeup determinations based on counter-based analysis to a top-down image and/or other image providing an external view of a material sample. Preparation of pixel data of the image for applying one or more contours can be provided to group pixels of the image, defined by the pixel data, into representative shapes.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings. It is noted that one or more drawings comprise one or more grey-scale images employed to illustrate grey scale levels of various pixels of such images.

FIG. 1 illustrates a block diagram of an example scientific instrument for performing one or more operations, in accordance with one or more embodiments described herein.

FIG. 2 illustrates a flow diagram of an example method of performing operations using the scientific instrument of FIG. 1, in accordance with one or more embodiments described herein.

FIG. 3 illustrates a graphical user interface (GUI) that can be used in the performance of one or more of the methods described herein, in accordance with one or more embodiments described herein.

FIG. 4 illustrates a block diagram of an example computing device that can perform one or more of the methods disclosed herein, in accordance with one or more embodiments described herein.

FIG. 5 illustrates a block diagram of an example, non-limiting system that can facilitate a process for image contour line extraction, in accordance with one or more embodiments described herein.

FIG. 6 illustrates a block diagram of another example, non-limiting system that can facilitate a process for image contour line extraction, in accordance with one or more embodiments described herein.

FIG. 7 provides a visual illustration of pixel processing of an exemplary image that can be analyzed by the non-limiting system of FIG. 6, in accordance with one or more embodiments described herein.

FIG. 8 provides a visual illustration of contour line extraction of the exemplary image of FIG. 7, that can be performed by the non-limiting system of FIG. 6, in accordance with one or more embodiments described herein.

FIG. 9 illustrates flow diagram of a set of processes that can be performed by the image contour line extraction system of FIG. 6, in accordance with one or more embodiments described herein.

FIG. 10 illustrates a flow diagram of one or more processes that can be performed by the image contour line extraction system of FIG. 6, in accordance with one or more embodiments described herein.

FIG. 11 illustrates another flow diagram of one or more processes that can be performed by the image contour line extraction system of FIG. 6, in accordance with one or more embodiments described herein.

FIG. 12 illustrates a continuation of the flow diagram of FIG. 11 of one or more processes that can be performed by the image contour line extraction system of FIG. 6, in accordance with one or more embodiments described herein.

FIG. 13 illustrates a block diagram of example scientific instrument system in which one or more of the methods described herein can be performed, in accordance with one or more embodiments described herein.

FIG. 14 illustrates a block diagram of an example operating environment into which embodiments of the subject matter described herein can be incorporated.

FIG. 15 illustrates an example schematic block diagram of a computing environment with which the subject matter described herein can interact and/or be implemented at least in part.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide a process for image contour line extraction, and particularly to address one or more inconsistencies corresponding to contour extraction and/or contour line extraction software, firmware and/or hardware that is existingly employed to generate one or more contours relative to an image of a material sample.

In accordance with an embodiment, a system can comprise a memory that stores computer executable components, and a processor that executes the computer executable components. The computer executable components can comprise an identifying component that identifies a contour line applied between regions of a pixelated image, and a subdividing component that subdivides the contour line into a set of barrier lines based on a parsing of contour line pixels of the contour line.

In accordance with another embodiment, a computer-implemented method can comprise subdividing, by a system operatively coupled to a processor, a contour line, applied between regions of a pixelated image, into a set of barrier lines, and generating, by the system, data employed for the subdividing by parsing contour line pixels, of the contour line.

In accordance with still another embodiment, a computer program product facilitates a process for image contour line extraction, the program instructions executable by a processor to cause the processor to identify, by the processor, a set of contour lines applied between regions of a pixelated image; and subdivide, by the processor, the set of contour lines into a set of barrier lines based on a parsing of contour line pixels of the set of contour lines.

The one or more embodiments described herein can be implemented within, in connection with and/or coupled to a scientific imaging device.

The one or more embodiments disclosed herein can achieve dynamic contour line extraction and subsequent modification, providing other than a one-size-fits-all approach. That is, different initially-identified contour lines of a same image can have different thicknesses, be located adjacent to pixels of different material types, etc. To address these intricacies, the one or more embodiments described herein can provide for contour line extraction based on various iterations of determination of neighbor pixels using a dynamically-adjustable pixel threshold, to provide a dynamically-adjustable accuracy of the modification.

In this way, the one or more embodiments described herein can address different pixelation types (e.g., patternings, gray scale levels, etc.) of different materials allowing for the one or more embodiments described herein to be diversely applicable to a wide range of applications, materials, material types, etc. For example, different pixel thresholds can be employed for different materials or even different portions of a same sample being analyzed and for which contour line extraction is being sought.

The one or more embodiments described herein can provide for sub-pixel accuracy of contour line extraction based on these functions and abilities to iterate selected neighbor pixels (e.g., used to define a contour line extraction) until a dynamically-adjustable pixel threshold is satisfied.

The one or more embodiments described herein can be employed to analyze images comprising cross-sectional views of samples, rather than merely being applicable to overhead views and/or other external views, as with existing frameworks for contour line determination. Accordingly, the one or more embodiments described herein can have increased applicability for different purposes and industries, as compared to existing frameworks.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Various operations can be described as multiple discrete actions or operations in turn, in a manner that is most helpful in understanding the subject matter disclosed herein. However, the order of description should not be construed as to imply that these operations are necessarily order dependent. In particular, these operations can be performed in an order different from the order of presentation. Operations described can be performed in a different order from the described embodiment. Various additional operations can be performed, and/or described operations can be omitted in additional embodiments.

Turning now to the subject of material analysis and to the one or more embodiments described herein, electron microscopy (EM) is one method of obtaining images that can illustrate structure of materials at a nanoscale, providing a way to understand links between material composition, structure and/or performance. This type of imaging can be used in a plurality of industries that include, but certainly are not limited to, computing systems, semiconductor manufacturing, chemical sensors, targeted drug delivery, high-performance materials, and water filters.

Briefly, an EM device can apply an energy source, such as a beam of electrons, to a target. The beam can affect molecules of the target such as by interacting with a nucleus where an electron of the beam can be backscattered with undiminished energy, or an electron of the beam can interact with orbiting electrons of sample atoms in a variety of ways. As a result, an electron can be ejected (e.g., near a surface of the sample), allowing for the liberated electron to escape the sample and to be detected as a secondary electron by a detector of the EM device.

As a result of the detection, an image can be generated, such as at a nanoscale, of a portion of the sample. In one or more embodiments, the image can be a pixelated image providing for subsequent evaluation of the pixelation of the image.

A remainder of discussion herein turns to analysis of such pixelated image. However, it is noted that such pixelated image, for which the one or more embodiments described herein can provide various analysis processes, can be obtained from any suitable scientific device, imaging process, etc. That is, signals other than an electron beam, such as X-rays, ion streams, cathodoluminescence, absorbed current, etc., can allow for detection of an output result and generation of a resulting pixelated image for subsequent post-processing and/or analysis.

In various cases, existing frameworks for post-processing of a pixelated image can comprise techniques for identifying and/or reducing effects of noise caused by the imaging process, application of a mask of lines to delineate sections of a pixelated image, consideration of coloring and/or intensity of pixelation, etc.

Some of the post-processing processes can comprise application of contour lines to trace boundaries of pixel groups, allowing for subsequent analysis of the pixels within the perimeter of such contour lines. This process can be referred to as contour extraction or contour line extraction, which is a process of tracing a boundary of a pixel group and returning a list of points that describe a perimeter of a shape of the pixel group.

The contour lines that are generated by existing frameworks can be defined as curves joining continuous points (e.g., along a determined boundary of a material) having a similar color and/or intensity. These contour lines can be a useful tool for shape analysis, object detection and/or object recognition.

For example, a bounded group of pixels can correspond to a material, allowing for a determination of one or more shapes, properties and/or quantities of the material and/or sub-section of a material. In another example, a bounded group of pixels can be analyzed to determine manufacturing consistency of different sections, parts, portions, interfaces, layers, etc. of a manufactured part. Such analyses can be based on any one or more of pixelation color, pixelation intensity, quantity of pixels, etc.

Existing techniques for applying a mask of contour lines to a pixelated image can comprise artificial intelligence (AI) segmentation, thresholding and/or watershed techniques.

Subsequent to application of the contour lines, the contour lines can be modified, revised, etc., such as providing for better fit of the contour lines to existing properties, shapes, contours, boundaries, etc. of the pixelated image.

In existing techniques, the contour line extraction processes (e.g., AI segmentation, thresholding and/or watershedding) can have significant deficiencies associated therewith. For example, these existing techniques can be inaccurate, subjective based on user entity-entered parameters, have difficulty determining boundaries at a sub-pixel level, apply a same contour line to various different material pair interfaces, fail to filter out noise, etc. For example, for complex structures (e.g., samples being imaged) wherein one body of the sample interfaces with multiple other bodies of the sample, existing frameworks can fail to accurately extract sub-pixel accurate contour lines for the one body.

Further, such existing techniques fail to take into account the differences between different sets of materials of an image, thus applying same parameters and contour lines to different sets of materials without basing such application on the differences. For example, existing frameworks can be body-centric, focusing on contour line extraction relative to a collection of pixels of a body. This does not account for bodies surrounded by and/or disposed adjacent to plural different and non-uniform materials, different interfaces with plural bodies by a single body, etc. Rather, a contour line can be extracted around a single body, regardless of the various interfaces of that single body with other bodies of the sample of different materials.

Accordingly, in view of the above-noted deficiencies, when refining the contour lines to a sub-pixel accuracy, there has been no processing relative to and/or differentiating between different interfaces of different materials. Accordingly, with existing contour line extraction frameworks, same parameters will be employed in the refining for all such interfaces, resulting in failure to accurately identify regions of a pixelated image relative to one another.

Therefore, to account for one or more inabilities and/or deficiencies of existing frameworks (e.g., existing image preparation frameworks), one or more embodiments are described herein that can employ a unique image preparation framework to achieve differentiated identification of barriers between different materials of a pixelated image, where the pixelated image can comprise a surface level image or a cross-sectional image of a sample comprising plural materials, bodies and/or interfaces. As a result of these frameworks, subsequent refining of the pixelated image, using differentiated barrier lines generated by the one or more frameworks, can be accurately performed to sub-pixel accuracy. The one or more processes performed by the one or more frameworks described herein can be executed without additional image processing, while providing a richer illustration/description of a sample than can be provided by existing frameworks.

Generally, the one or more embodiments described herein can employ a process of contour line extraction based on a warm-start of baseline contour line extraction provided by an existing framework. That is, the contour lines generated by an existing framework can be broken down, e.g., subdivided, into a set of differentiated barrier lines, allowing for different parameters to be applied to different material interfaces (e.g., the barrier lines) in a subsequent refinement stage.

Discussion next turns to a general discussion of one or more scientific instrument systems disclosed herein, as well as to related methods, computing devices, and/or computer-readable media. For example, in one or more embodiments, a system can comprise a memory that stores computer executable components and a processor that executes the computer executable components stored in the memory. The computer executable components can comprise an identifying component that identifies a contour line applied between regions of a pixelated image, and a subdividing component that subdivides the contour line into a set of barrier lines based on a parsing of contour line pixels of the contour line.

The one or more embodiments disclosed herein can achieve improved performance relative to existing approaches, as noted above. For example, based on application of a filter kernel over the pixelated image, and parsing performed according to the convolving using the filter kernel, separate barrier lines of different interfaces of the pixelated image can be generated. That is, use of the one or more contour line extraction frameworks discussed herein can allow for provision of differentiation that is not possible using existing frameworks.

The embodiments disclosed herein thus can provide improvements to scientific instrument technology (e.g., improvements in the computer technology supporting such scientific instruments, among other improvements), which can be employed in various fields including optics, signal processing, spectroscopy, and/or nuclear magnetic resonance (NMR), without being limited thereto.

Various ones of the embodiments disclosed herein can improve upon existing approaches to achieve the technical advantages of high information and/or accurate information contour line extraction. That is, the one or more frameworks described herein can provide a more accurate construction, as compared to existing frameworks, of a set of contour lines of an image, thereby allowing for identification of different regions delineated by the set of contour lines. The different regions can correspond to different sub-materials, with the contour lines corresponding to best approximate separations between sub-materials, even where a set of sub-materials can be intermixed, combined, etc., such as at a region between corresponding purer sections of the sub-materials. The image can originally arise from any suitable scientific imaging device source using any suitable method, such as electron holography imaging, scanning electron microscope (SEM) imaging, electron microscope (EM) imaging, and/or the like.

Such technical advantages are not achievable by routine and/or existing approaches, and all user entities of systems including such embodiments can benefit from these advantages (e.g., by assisting the user entity in the performance of a technical task, such as identification of one or more target compositions of an image, by means of image preparation using an image contour line extraction framework discussed herein).

The technical features of the embodiments disclosed herein (e.g., analysis of a contour line based on a quantity of adjacent pixels) are thus decidedly unconventional in the field of material analysis, in addition to the fields of optics, signal processing, spectroscopy, and/or NMR, without being limited thereto, as are combinations of the features of the embodiments disclosed herein.

As discussed further herein, various aspects of the embodiments disclosed herein can improve the functionality of a computer itself. That is, the computational and/or user interface features disclosed herein do not involve only the collection and/or comparison of information but instead can apply new analytical and technical techniques to change the operation of the computer-analysis of material compounds. For example, based on the subdivision of a contour line into a set of two or more barrier lines, thus delineating the different interfaces of the original contour line, different parameters and/or techniques can be employed by a computing system to revise the barrier lines, based specifically on the extraction of the separate barrier lines in the first instance. As such, one or more non-limiting systems described herein, comprising an image contour extraction system, can be self-improving by automatic extraction and subsequent use of the barrier lines.

The present disclosure thus introduces functionality that neither an existing computing device, nor a human, could perform. Rather, such existing computing devices are ineffective at identification, subdivision and/or processing of delineated contour lines, resulting in loss of information when evaluating a pixelated image and/or when revising location of a portion of a contour line. In view of the time, energy and/or loss of data involved, it is not practical to operate within the confines of existing approaches.

Accordingly, the embodiments of the present disclosure can serve any of a number of technical purposes, such as controlling a specific technical system or process; determining from measurements how to control a machine; digital audio, image, or video enhancement or analysis; separation of material sources in a mixed signal; generating data for reliable and/or efficient transmission or storage; providing estimates and confidence intervals for material samples; or providing a faster processing of sensor data. In particular, the present disclosure provides technical solutions to technical problems, including, but not limited to, hologram modification; image/signal blurring; application of combined blurring techniques; and/or subsequent image reconstruction, resulting in a faster, more thorough and/or more efficient processing of generated images and thus of material samples or other target compositions being imaged.

The embodiments disclosed herein thus provide improvements to material analysis technology (e.g., improvements in the computer technology supporting material analysis, among other improvements).

As used herein, the phrase “based on” should be understood to mean “based at least in part on,” unless otherwise specified.

As used herein, the term “component” can refer to an atomic element, molecular element, phase of an atomic or molecular element, or combination thereof.

As used herein, the term “data” can comprise metadata.

As used herein, the terms “entity,” “requesting entity,” and “user entity” can refer to a machine, device, component, hardware, software, smart device, party, organization, individual and/or human.

As used herein, the term “sample” can refer to a product, material, component, compound, etc.

One or more embodiments are now described with reference to the drawings, where like referenced numerals are used to refer to like drawing elements throughout. In the following description, for purposes of explanation, numerous specific details are set forth in order to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

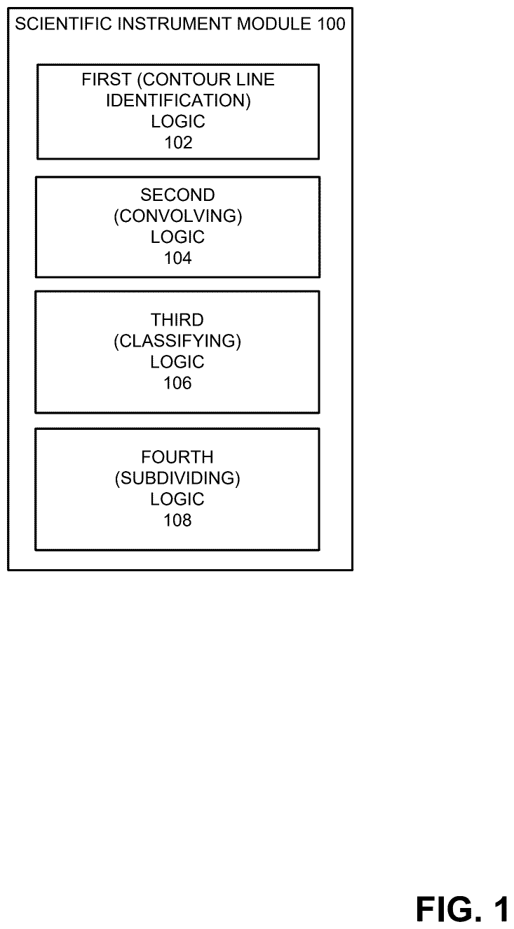

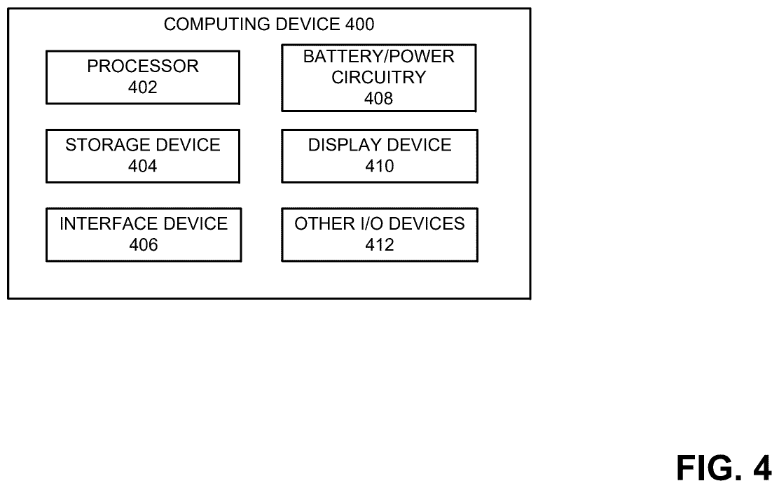

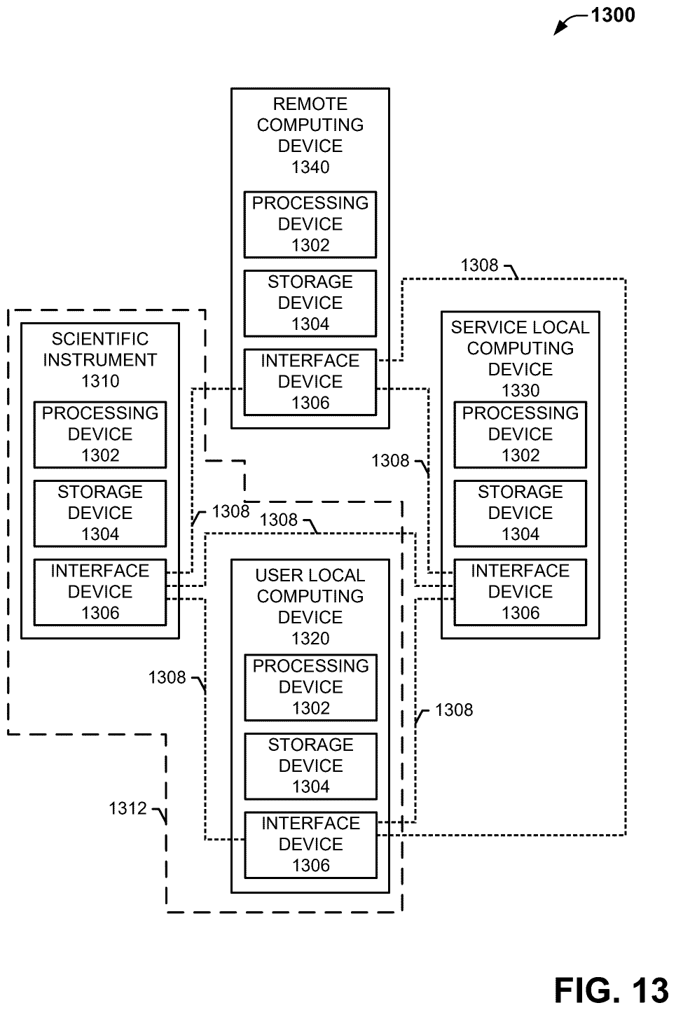

Turning now in particular to the one or more figures, and first to FIG. 1, illustrated is a block diagram of a scientific instrument module 100 for performing material analysis operations using a contour line extraction process based on a warm-start of an existing contour extraction, in accordance with various embodiments described herein. The scientific instrument module 100 can be implemented by circuitry (e.g., including electrical and/or optical components), such as a programmed computing device. The logic of the scientific instrument module 100 can be included in a single computing device or can be distributed across multiple computing devices that are in communication with each other as appropriate. Examples of computing devices that can, singly or in combination, implement the scientific instrument module 100 are discussed herein with reference to the computing device 400 of FIG. 4, and examples of systems of interconnected computing devices, in which the scientific instrument module 100 can be implemented across one or more of the computing devices, is discussed herein with reference to the scientific instrument system 1300 of FIG. 13.

The scientific instrument module 100 can include first logic 102, second logic 104, third logic 106, and fourth logic 108. As used herein, the term “logic” can include an apparatus that is to perform a set of operations associated with the logic. For example, any of the logic elements included in the module 100 can be implemented by one or more computing devices programmed with instructions to cause one or more processing devices of the computing devices to perform the associated set of operations. In a particular embodiment, a logic element can include one or more non-transitory computer-readable media having instructions thereon that, when executed by one or more processing devices of one or more computing devices, cause the one or more computing devices to perform the associated set of operations. As used herein, the term “module” can refer to a collection of one or more logic elements that, together, perform a function associated with the module. Different ones of the logic elements in a module can take the same form or can take different forms. For example, some logic in a module can be implemented by a programmed general-purpose processing device, while other logic in a module can be implemented by an application-specific integrated circuit (ASIC). In another example, different ones of the logic elements in a module can be associated with different sets of instructions executed by one or more processing devices. A module can omit one or more of the logic elements depicted in the associated drawing; for example, a module can include a subset of the logic elements depicted in the associated drawing when that module is to perform a subset of the operations discussed herein with reference to that module.

The first logic 102 can receive, find, locate, download, request, measure and/or otherwise determine data and/or metadata defining a pre-processed contour line (e.g., boundary) between a set of regions of a pixelated image. That is, the first logic 102 can obtain data for being processed and for subsequent use in generating a set of differentiated barrier lines from the contour line.

The second logic 104 can perform a convolving process by convolving a filter kernel over the pixelated image, resulting in an ability to determine contour line pixels from non-contour line pixels of the pixelated image. That is, the second logic 104 can employ the output of the first logic 102 to further modify a pixelated image.

The third logic 106 can parse the contour line pixels of a contour line and determine a number of neighbor pixels for each contour line pixel parsed. Neighbor pixels can refer to contour line pixels and/or non-contour line pixels that are adjacent to, such as contiguous with, a contour line pixel. That is, the third logic 106 can obtain data for being processed and for subsequent use in generating a modified pixelated image comprising barrier lines.

The fourth logic 108 can generate the set of barrier lines, allowing for subdividing of the contour line. That is, the fourth logic 108 can determine endpoints of barrier lines and/or intersections of barrier lines based on the output of the third logic 106.

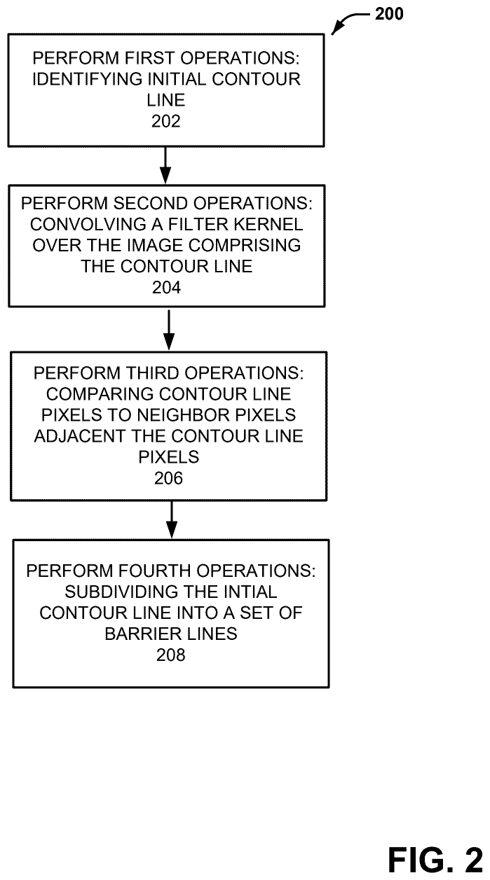

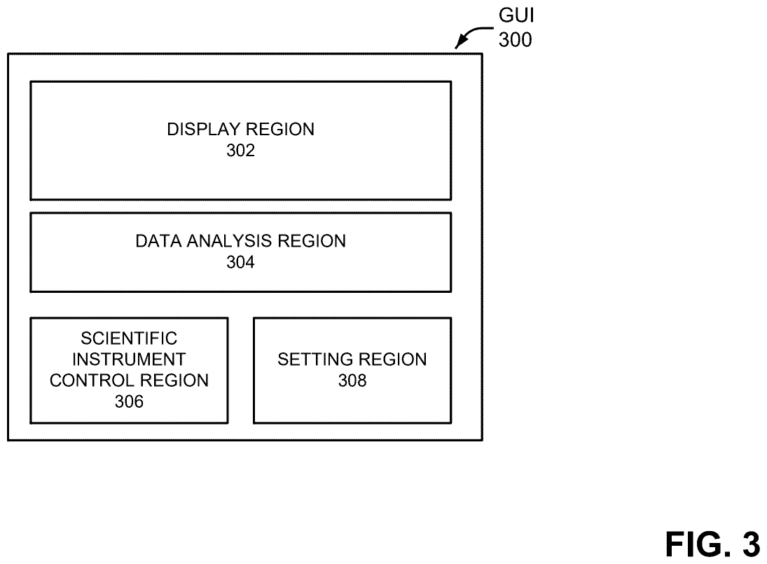

FIG. 2 illustrates a flow diagram of a method 200 of performing operations, by the scientific instrument module 100, in accordance with various embodiments. Although the operations of the method 200 can be illustrated with reference to particular embodiments disclosed herein (e.g., the scientific instrument module 100 discussed herein with reference to FIG. 1, the GUI 300 discussed herein with reference to FIG. 3, the computing device 400 discussed herein with reference to FIG. 4, and/or the scientific instrument system 1300 discussed herein with reference to FIG. 13), the method 200 can be used in any suitable setting to perform any suitable operations. Operations are illustrated once each and in a particular order in FIG. 2, but the operations can be reordered and/or repeated as desired and appropriate (e.g., different operations performed can be performed in parallel, as suitable).

At 202, first operations can be performed. For example, the first logic 102 of the module 100 can perform the first operations 202. The first operations 202 can include receiving, finding, locating, downloading, requesting, measuring and/or otherwise determining data and/or metadata defining a contour line (e.g., defining contour line pixels) of a pixelated image.

At 204, second operations can be performed. For example, the second logic 104 of the module 100 can perform the second operations 204. The second operations 204 can comprise employing a filter kernel applied to data of the pixelated image to provide a mask for use by the third logic 106.

At 206, third operations can be performed. For example, the third logic 106 of the module 100 can perform the third operations 206. The third operations 206 can comprise comparing contour line pixels to neighbor pixels that are adjacent to, such as contiguous with, a contour line pixel to determine a number of neighbor pixels corresponding to each contour line pixel parsed by the third logic 106.

At 208, fourth operations can be performed. For example, the fourth logic 108 of the module 100 can perform the fourth operations 208. The fourth operations 208 can comprise generation of a set barrier lines from a single contour line, thereby allowing for subdividing of the contour line into differentiated interfaces.

The scientific instrument methods disclosed herein can include interactions with a user entity (e.g., via the user local computing device 1320 discussed herein with reference to FIG. 13). These interactions can include providing information to the user entity (e.g., information regarding the operation of a scientific instrument such as the scientific instrument 1310 of FIG. 13, information regarding a sample being analyzed or other test or measurement performed by a scientific instrument, information retrieved from a local or remote database, or other information) or providing an option for a user entity to input commands (e.g., to control the operation of a scientific instrument such as the scientific instrument 1310 of FIG. 13, or to control the analysis of data generated by a scientific instrument), queries (e.g., to a local or remote database), or other information. In some embodiments, these interactions can be performed through a graphical user interface (GUI) that includes a visual display on a display device (e.g., the display device 410 discussed herein with reference to FIG. 4) that provides outputs to the user entity and/or prompts the user entity to provide inputs (e.g., via one or more input devices, such as a keyboard, mouse, trackpad, or touchscreen, included in the other I/O devices 412 discussed herein with reference to FIG. 4). The scientific instrument system 1300 disclosed herein can include any suitable GUIs for interaction with a user entity.

Turning next to FIG. 3, depicted is an example GUI 300 that can be used in the performance of one or more of the methods described herein, in accordance with various embodiments described herein. As noted above, the GUI 300 can be provided on a display device (e.g., the display device 410 discussed herein with reference to FIG. 4) of a computing device (e.g., the computing device 400 discussed herein with reference to FIG. 4) of a scientific instrument system (e.g., the scientific instrument system 1300 discussed herein with reference to FIG. 13), and a user entity can interact with the GUI 300 using any suitable input device (e.g., any of the input devices included in the other I/O devices 412 discussed herein with reference to FIG. 4) and input technique (e.g., movement of a cursor, motion capture, facial recognition, gesture detection, voice recognition, actuation of buttons, etc.).

The GUI 300 can include a data display region 302, a data analysis region 304, a scientific instrument control region 306, and a settings region 308. The particular number and arrangement of regions depicted in FIG. 3 is merely illustrative, and any number and arrangement of regions, including any desired features thereof, can be included in a GUI 300.

The data display region 302 can display data generated by a scientific instrument (e.g., the scientific instrument 1310 discussed herein with reference to FIG. 13). For example, the data display region 302 can display one or more output results which can comprise a pixelated image, portion of a pixelated image, text, graphs, notification, charts, matrices and/or spectra, without being limited thereto.

The data analysis region 304 can display the results of data analysis (e.g., the results of analyzing the data illustrated in the data display region 302 and/or other data). For example, the data analysis region 304 can display one or more of the output results. In one or more cases, the data analysis region 304 can display a list, flow chart or other schematic of acquisition actions taken and/or recommended relative to an experiment. In one or more embodiments, the data display region 302 and the data analysis region 304 can be combined in the GUI 300 (e.g., to include data output from a scientific instrument, and some analysis of the data, in a common graph or region).

The scientific instrument control region 306 can include options that allow the user entity to control a scientific instrument (e.g., the scientific instrument 1310 discussed herein with reference to FIG. 13). For example, the scientific instrument control region 306 can include one or more controls for inputting one or more parsing parameters, neighbor pixel parameters, data storage parameters and/or the like.

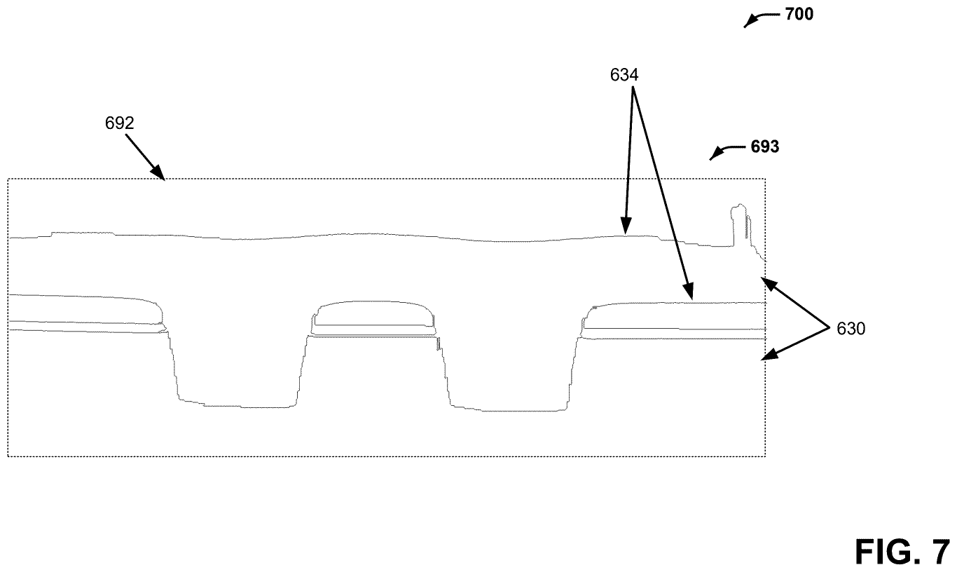

The settings region 308 can include options that allow the user entity to control the features and functions of the GUI 300 (and/or other GUIs) and/or perform common computing operations with respect to the data display region 302 and data analysis region 304 (e.g., saving data on a storage device, such as the storage device 404 discussed herein with reference to FIG. 4, sending data to another user entity, labeling data, etc.). For example, the settings region 308 can include one or more options to alter color, fill or format of illustrations, such as an illustration of any aspect of FIGS. 7-9 and/or other image, whether actual, representative and/or schematic, to be described below.

As noted above, the scientific instrument module 100 can be implemented by one or more computing devices. Accordingly, discussion next turns to FIG. 4, which illustrates a block diagram of a computing device 400 that can perform some or all of the scientific instrument methods disclosed herein, in accordance with various embodiments. In one or more embodiments, the scientific instrument module 100 can be implemented by a single computing device 400 or by multiple computing devices 400. Further, as discussed below, a computing device 400 (or multiple computing devices 400) that implements the scientific instrument module 100 can be part of one or more of the scientific instrument 1310, the user local computing device 1320, the service local computing device 1330, or the remote computing device 1340 of FIG. 13.

The computing device 400 of FIG. 4 is illustrated as having a number of components, but any one or more of these components can be omitted or duplicated, as suitable for the application and setting. As illustrated, these components can include one or more of a processor 402, storage device 404, interface device 406, battery/power circuitry 408, display device 410 and other input/output (I/O) devices 412, as will be described below.

In one or more embodiments, one or more of the components included in the computing device 400 can be attached to one or more motherboards and enclosed in a housing (e.g., including plastic, metal, and/or other materials). In one or more embodiments, some these components can be fabricated onto a single system-on-a-chip (SoC) (e.g., an SoC can include one or more processors 402 and one or more storage devices 404). Additionally, in one or more embodiments, the computing device 400 can omit one or more of the components illustrated in FIG. 4. In one or more embodiments, the computing device 400 can include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 400 can omit a display device 410, but can include display device interface circuitry (e.g., a connector and driver circuitry) to which a display device 410 can be coupled.

The computing device 400 can include the processor 402 (e.g., one or more processing devices). As used herein, the term “processing device” can refer to any device or portion of a device that processes electronic data from registers and/or memory to transform that electronic data into other electronic data that can be stored in registers and/or memory. The processor 402 can include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 400 can include a storage device 404 (e.g., one or more storage devices). The storage device 404 can include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In one or more embodiments, the storage device 404 can include memory that shares a die with a processor 402. In such an embodiment, the memory can be used as cache memory and can include embedded dynamic random-access memory (eDRAM) or spin transfer torque magnetic random-access memory (STT-MRAM), for example. In one or more embodiments, the storage device 404 can include non-transitory computer readable media having instructions thereon that, when executed by one or more processing devices (e.g., the processor 402), cause the computing device 400 to perform any appropriate ones of or portions of the methods disclosed herein.

The computing device 400 can include an interface device 406 (e.g., one or more interface devices 406). The interface device 406 can include one or more communication chips, connectors, and/or other hardware and software to govern communications between the computing device 400 and other computing devices. For example, the interface device 406 can include circuitry for managing wireless communications for the transfer of data to and from the computing device 400. The term “wireless” and its derivatives can be used to describe circuits, devices, systems, methods, techniques, communications channels, etc., that can communicate data through the use of modulated electromagnetic radiation through a nonsolid medium. The term does not imply that the associated devices do not contain any wires, although in one or more embodiments the associated devices might not contain any wires. Circuitry included in the interface device 406 for managing wireless communications can implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In one or more embodiments, circuitry included in the interface device 406 for managing wireless communications can operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In one or more embodiments, circuitry included in the interface device 406 for managing wireless communications can operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In one or more embodiments, circuitry included in the interface device 406 for managing wireless communications can operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In one or more embodiments, the interface device 406 can include one or more antennas (e.g., one or more antenna arrays) to receipt and/or transmission of wireless communications.

In one or more embodiments, the interface device 406 can include circuitry for managing wired communications, such as electrical, optical, or any other suitable communication protocols. For example, the interface device 406 can include circuitry to support communications in accordance with Ethernet technologies. In one or more embodiments, the interface device 406 can support both wireless and wired communication, and/or can support multiple wired communication protocols and/or multiple wireless communication protocols. For example, a first set of circuitry of the interface device 406 can be dedicated to shorter-range wireless communications such as Wi-Fi or Bluetooth, and a second set of circuitry of the interface device 406 can be dedicated to longer-range wireless communications such as global positioning system (GPS), EDGE, GPRS, CDMA, WiMAX, LTE, EV-DO, or others. In one or more embodiments, a first set of circuitry of the interface device 406 can be dedicated to wireless communications, and a second set of circuitry of the interface device 406 can be dedicated to wired communications.

The computing device 400 can include battery/power circuitry 408. The battery/power circuitry 408 can include one or more energy storage devices (e.g., batteries or capacitors) and/or circuitry for coupling components of the computing device 400 to an energy source separate from the computing device 400 (e.g., AC line power).

The computing device 400 can include a display device 410 (e.g., multiple display devices). The display device 410 can include any visual indicators, such as a heads-up display, a computer monitor, a projector, a touchscreen display, a liquid crystal display (LCD), a light-emitting diode display, or a flat panel display.

The computing device 400 can include other input/output (I/O) devices 412. The other I/O devices 412 can include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 400, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 400 can have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

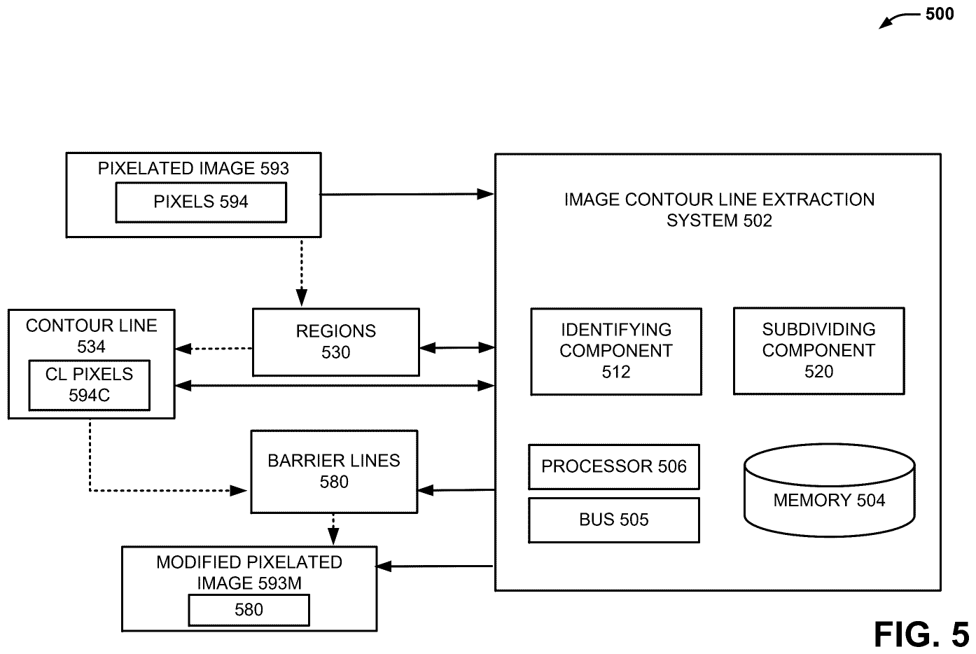

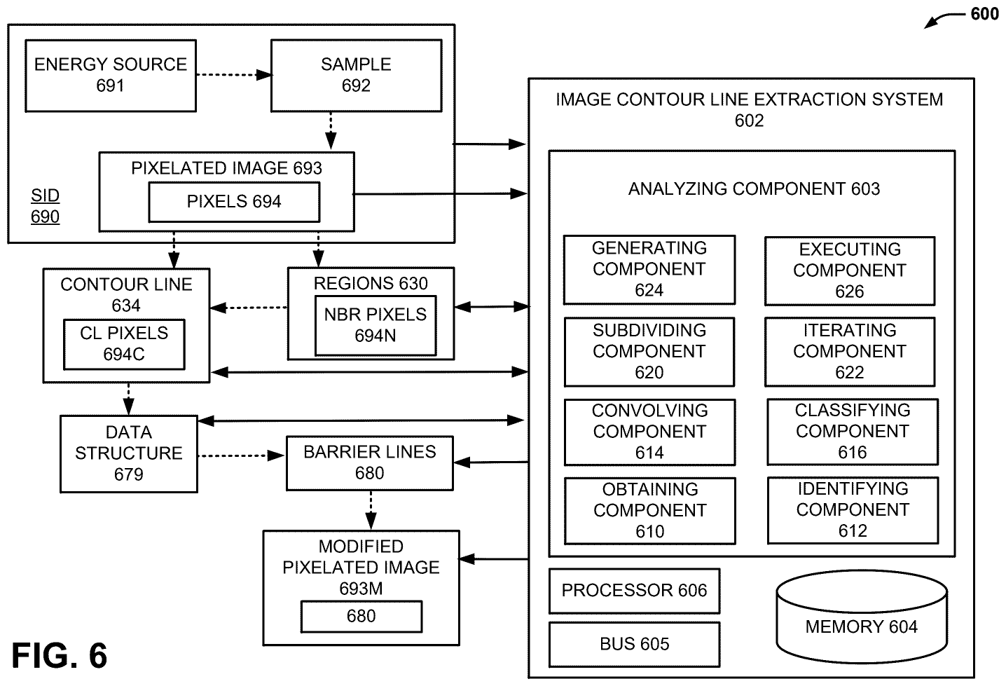

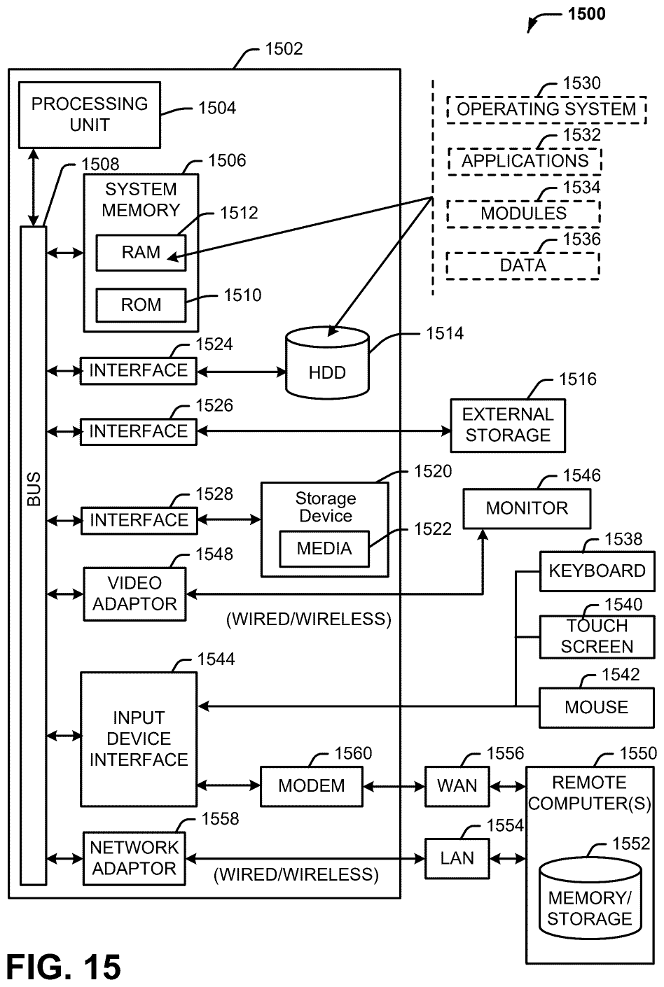

Referring now to FIGS. 5 and 6, in one or more embodiments, the non-limiting systems 500 and/or 600 illustrated at FIGS. 5 and 6, and/or systems thereof, can further comprise one or more computer and/or computing-based elements described herein with reference to a computing environment, such as the computing environment 1500 illustrated at FIG. 15. In one or more described embodiments, computer and/or computing-based elements can be used in connection with implementing one or more of the systems, devices, components and/or computer-implemented operations shown and/or described in connection with FIGS. 5 and/or 6 and/or with other figures described herein.

Turning first to FIG. 5, the figure illustrates a block diagram of an example, non-limiting system 500 that can comprise an image contour line extraction system 502. The image contour line extraction system 502 can facilitate a process for pixelated image contour line extraction of a pixelated image 593 comprising a set of pixels 594.

In one or more embodiments, the image contour line extraction system 502 can be at least partially comprised by the computing device 400.

In one or more embodiments, the image contour line extraction system 502 can at least partially comprise and/or be comprised by an imaging device having generated the pixelated image 593 and/or vice versa.

It is noted that the image contour line extraction system 502 is only briefly detailed to provide but a lead-in to a more complex and/or more expansive image contour line extraction system 602 as illustrated at FIG. 6. That is, further detail regarding processes that can be performed by one or more embodiments described herein will be provided below relative to the non-limiting system 600 of FIG. 6.

Still referring to FIG. 5, the image contour line extraction system 502 can comprise at least a memory 504, bus 505, processor 506, identifying component 512, and/or subdividing component 520. The processor 506 can be the same as the processor 402, comprised by the processor 402 or different therefrom. The memory 504 can be the same as the storage device 404, comprised by the storage device 404 or different therefrom.

Using the above-noted components, the image contour line extraction system 502 can facilitate a process to at least partially modify the pixelated image 593 through generation of a set of barrier lines 580 subdivided from a contour line 534.

Generally, the identifying component 512 can obtain, find, locate, download and/or request data/metadata defining a contour line 534 applied between regions 530 of the pixelated image 593. That is, the identifying component 512 can identify information directed to and/or directly identify a set of contour line pixels 594C comprised by the contour line 534.

The subdividing component 520 can, based on a parsing of the contour line pixels 593, generate the set of barrier lines 580 by subdividing the contour line 534 into the set of barrier lines 580.

As a result of these components, a modified pixelated image 593M can be generated comprising the barrier lines 580, which modified pixelated image 593M can be employed for post-processing. As noted above, the post-processing can comprise, but is not limited to, refinement of the barrier lines 580, such as moving a portion of a barrier line 580. Also as noted above, this refining can be performed using differentiated parameters for different interfaces (e.g., different interfaces of different materials represented by the barrier lines 580). The enablement of use of the differentiated parameters is based on the application of the barrier lines 580 by the non-limiting system 500.

The identifying component 512 and/or subdividing component 520 can be operatively coupled to the processor 506 which can be operatively coupled to the memory 504. The bus 505 can provide for the operative coupling. The processor 506 can facilitate execution of the identifying component 512 and/or subdividing component. The identifying component 512 and/or subdividing component can be stored at the memory 504.

In general, the non-limiting system 500 can employ any suitable method of communication (e.g., electronic, communicative, internet, infrared, fiber, etc.) to provide communication between the image contour line extraction system 502, a pixelated image generated device, and/or any device associated with a user entity.

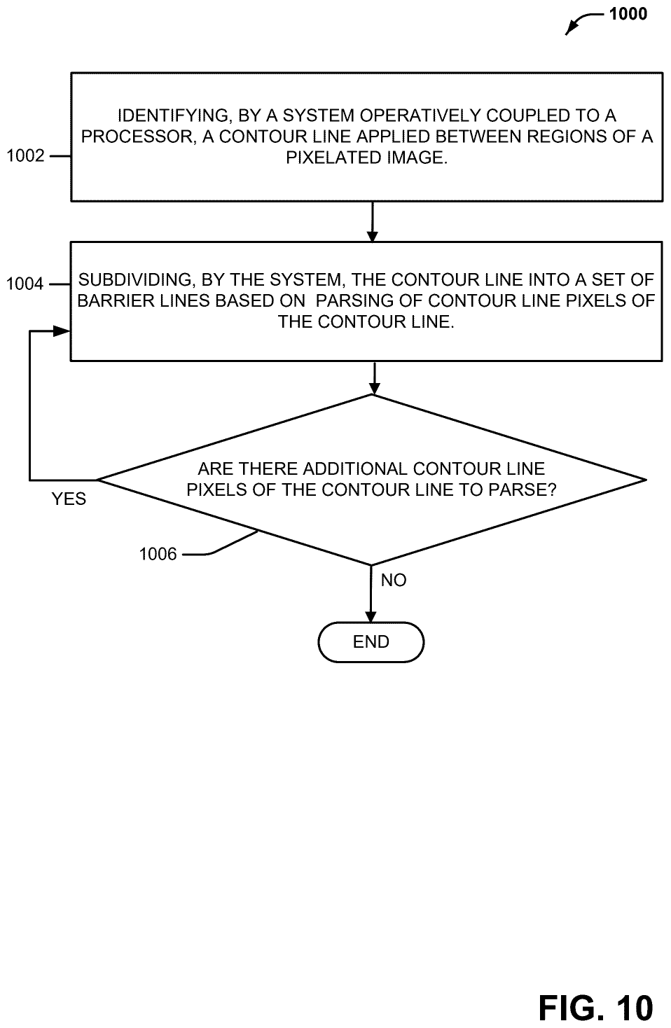

As a summary of the above-described components and functions thereof, referring next only briefly to FIG. 10, illustrated is a flow diagram of an example, non-limiting method 1000 that can facilitate a process contour line extraction of a pixelated image, in accordance with one or more embodiments described herein, such as the non-limiting system 500 of FIG. 5. While the non-limiting method 1000 is described relative to the non-limiting system 500 of FIG. 5, the non-limiting method 1000 can be applicable also to other systems described herein, such as the non-limiting system 600 of FIG. 6. Repetitive description of like elements and/or processes employed in respective embodiments is omitted for sake of brevity.

At 1002, the non-limiting method 1000 can comprise identifying, by a system (e.g., identifying component 512) operatively coupled to a processor (e.g., processor 506), a contour line (e.g., contour line 534) applied between regions (e.g., regions 530) of a pixelated image (e.g., pixelated image 593).

At 1004, the non-limiting method 1000 can comprise subdividing, by the system (e.g., subdividing component 520), the contour line into a set of barrier lines (e.g., barrier lines 580) based on parsing of contour line pixels (e.g., contour line pixels 594C) of the contour line.

At 1006, the non-limiting method 1000 can comprise determining, by the system (e.g., subdividing component 520), whether there are additional contour line pixels of the contour line to parse. If yes, the method 1000 can proceed back to step 1004. If not, the method 1000 can end.

Turning next to FIG. 6, a non-limiting system 600 is illustrated that can comprise an image contour line extraction system 602 and scientific imaging device (SID) 690. Repetitive description of like elements and/or processes employed in respective embodiments is omitted for sake of brevity. Description relative to an embodiment of FIG. 5 can be applicable to an embodiment of FIG. 6. Likewise, description relative to an embodiment of FIG. 6 can be applicable to an embodiment of FIG. 5.

Generally, the image contour line extraction system 602 can facilitate a process to at least partially modify the pixelated image 693 through generation of a set of barrier lines 680 subdivided from a contour line 634.

The non-limiting system 600 can be employed in connection with a pixelated image generating device, such as the SID 690.

In one or more embodiments, the image contour line extraction system 602 can be at least partially comprised by the computing device 400.

In one or more embodiments, the image contour line extraction system 602 can at least partially comprise the SID 690 and/or vice versa.

One or more communications between one or more components of the non-limiting system 800 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The image contour line extraction system 602 can be associated with, such as accessible via, a cloud computing environment, such as the cloud computing environment 1500 of FIG. 15.

The image contour line extraction system 602 can comprise a plurality of components. The components can comprise a memory 604, processor 606, bus 605, obtaining component 610, identifying component 612, convolving component 614, classifying 616, subdividing component 620, iterating component 622, generating component 624 and/or executing component 626. Using these components, the image contour line extraction system 602 can output at least a set of barrier lines 680 for at least a contour line 634 of the pixelated image 693.

Discussion next turns to the processor 606, memory 604 and bus 605 of the image contour line extraction system 602. For example, in one or more embodiments, the image contour line extraction system 602 can comprise the processor 606 (e.g., computer processing unit, microprocessor, classical processor, quantum processor and/or like processor). In one or more embodiments, a component associated with image contour line extraction system 602, as described herein with or without reference to the one or more figures of the one or more embodiments, can comprise one or more computer and/or machine readable, writable and/or executable components and/or instructions that can be executed by processor 606 to provide performance of one or more processes defined by such component and/or instruction. In one or more embodiments, the processor 606 can comprise the obtaining component 610, identifying component 612, convolving component 614, classifying 616, subdividing component 620, iterating component 622, generating component 624 and/or executing component 626.

In one or more embodiments, the image contour line extraction system 602 can comprise the computer-readable memory 604 that can be operably connected to the processor 606. The memory 604 can store computer-executable instructions that, upon execution by the processor 606, can cause the processor 606 and/or one or more other components of the image contour line extraction system 602 (e.g., obtaining component 610, identifying component 612, convolving component 614, classifying 616, subdividing component 620, iterating component 622, generating component 624 and/or executing component 626) to perform one or more actions. In one or more embodiments, the memory 604 can store computer-executable components (e.g., obtaining component 610, identifying component 612, convolving component 614, classifying 616, subdividing component 620, iterating component 622, generating component 624 and/or executing component 626).

The image contour line extraction system 602 and/or a component thereof as described herein, can be communicatively, electrically, operatively, optically and/or otherwise coupled to one another via a bus 605. Bus 605 can comprise one or more of a memory bus, memory controller, peripheral bus, external bus, local bus, quantum bus and/or another type of bus that can employ one or more bus architectures. One or more of these examples of bus 605 can be employed.

In one or more embodiments, the image contour line extraction system 602 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the image contour line extraction system 602 and/or of the non-limiting system 600 can reside in the cloud, and/or can reside locally in a local computing environment (e.g., at a specified location).

In addition to the processor 606 and/or memory 604 described above, the image contour line extraction system 602 can comprise one or more computer and/or machine readable, writable and/or executable components and/or instructions that, when executed by processor 606, can provide performance of one or more operations defined by such component and/or instruction.

Discussion next turns to the additional components of the image contour line extraction system 602 (e.g., obtaining component 610, identifying component 612, convolving component 614, classifying 616, subdividing component 620, iterating component 622, generating component 624 and/or executing component 626), generally, the image contour line extraction system 602 can perform a set of processes that can be separated into various steps comprising, but not limited to: contour line pixel analysis, barrier line generation, and/or barrier line use.

First, it is noted that in one or more embodiments, the obtaining component 610, identifying component 612, convolving component 614, classifying 616, subdividing component 620, iterating component 622, generating component 624 and/or executing component 626 can be implemented independently, without one or more other of the obtaining component 610, identifying component 612, convolving component 614, classifying 616, subdividing component 620, iterating component 622, generating component 624 and/or executing component 626. Additionally and/or alternatively, the obtaining component 610, identifying component 612, convolving component 614, classifying 616, subdividing component 620, iterating component 622, generating component 624 and/or executing component 626 can be comprised by a high-level analyzing component 603, one or more of the below-described functions of the obtaining component 610, identifying component 612, convolving component 614, classifying 616, subdividing component 620, iterating component 622, generating component 624 and/or executing component 626 can be performed by the high-level analyzing component 603, and/or the obtaining component 610, identifying component 612, convolving component 614, classifying 616, subdividing component 620, iterating component 622, generating component 624 and/or executing component 626 can be omitted with the high-level analyzing component 603 performing one or more of the below-described functions of the one or more omitted obtaining component 610, identifying component 612, convolving component 614, classifying 616, subdividing component 620, iterating component 622, generating component 624 and/or executing component 626.

Turning first to the obtaining component 610, this component can generally acquire (e.g., obtain, locate, identify, request, download, etc.) a pixelated image 693 such as from a scientific imaging device 690. The pixelated image 693 can be of at least a portion of a sample 692, based on an application by the SID 690 of an energy source 691 to the sample 692.

Turning briefly to the illustration 700 of FIG. 7, and still referring to FIG. 6, the pixelated image 693 can be and/or comprise a surface or external image of the sample 692 and/or can be and/or comprise a cross-sectional image of the sample 692. Notably, existing frameworks cannot reliably address (e.g., perform contour extraction, also referred to as contour line extraction) relative to a cross-sectional image. This can be because a contrast mechanism employed is generally a material z-value. For example, a cross-sectional image can comprise a set of two or more, such as four or more, different regions 630 each corresponding to a different material of the sample 692. Any one or more regions 630 can abut (e.g., interface with) one or more other regions 630. Any one of such one or more other regions 630 can have different grayscale characteristics than the regions 630 they abut.

It is noted that gray-scaling of pixelation of the one or more regions 630 is removed form the illustration 700 for simplicity, to illustrate the contour lines 634.

A pixelated image 693 can comprise a contour line 634 already having been generated by another process, technique, system, device, etc. This contour line 634 is generally a closed contour line with no endpoints that bounds, such as surrounds, a shape (e.g., a grouping of pixels of generally similar grayscale characteristics). That is, the contour line extraction, of first identification of a contour line as a boundary between regions 630 of the pixelated image 693, can be warm-started (e.g., performed other than by the one or more processes described herein as being performed by the one or more embodiments described herein).

A region 630 can be comprised of a set of non-contour line pixels 694. A contour line 634 can be comprised of a set of contour line pixels 694C. Neighbor pixels 694N, to be employed for classifying the contour line pixels 694C, can be pixels that are adjacent to (e.g., contiguous with and/or abutting) contour line pixels 694C. In one or more embodiments, neighbor pixels 694N can be contour line pixels that are adjacent to (e.g., contiguous with and/or abutting) contour line pixels 694C. In such case, a neighbor pixel 694N can be of the same contour line or of a different contour line as a corresponding contour line pixel 694C. In one or more alternative embodiments, neighbor pixels 694N can be non-contour line pixels that are adjacent to (e.g., contiguous with and/or abutting) contour line pixels 694C.

As used herein, regardless of the embodiment, the term contiguous can refer to contiguous with a point or with a side of a pixel. In one or more other embodiments, the steps described below can be modified such that contiguous can refer to only contiguous with a point of a pixel or only contiguous with a side of a pixel.

Based on an output of the obtaining component 610, the identifying component 612 can generally identify data and/or metadata defining a contour line 634 of the pixelated image 693. This identifying can comprise identifying a set of contour line pixels 694C of which the contour line 634 is made up.

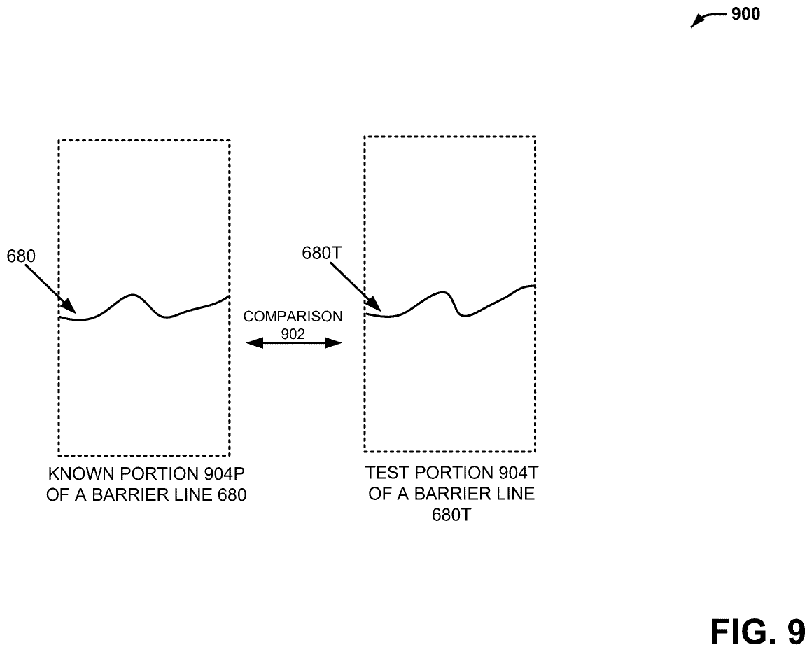

For example, attention turns now briefly to a discussion of scaling relative to the one or more processes that can be performed by the one or more embodiments described herein. For example, any two or more contour lines 634 of a same pixelated image 693 can be analyzed and processed at least partially in parallel with one another. Based on hardware and/or firmware capabilities associated with and/or employed by the non-limiting system 600, any two or more pixelated images 693 can be analyzed and/or processed at least partially in parallel with one another. This can be helpful in terms of use of the barrier lines 680, to be discussed below relative to the executing component 626 and FIG. 9, for comparing two or more pixelated images 693 to one another based on exact pixel mapping of pixels of barrier lines 680 of each of the two or more pixelated images 693.

Having identified the contour line pixels 694C and/or pixelated image 693 in general, the convolving component 614 can generally generate a mask that can be employed by the classifying component 616 to automatically determine and analyze quantities of neighbor pixels 694N per contour line pixel 694C, such as parsing plural contour line pixels 694C at a same time as one another.

That is, the convolving component 615 can convolve a filter kernel over the pixelated image 693, resulting in a determination of a quantity of neighbor pixels 694N adjacent to the contour line pixels 694C. For example, a mask can comprise ((1 1 1) (1 0 1) (1 1 1)) for diagonal or 8-fold connectivity and ((0 1 0) (1 0 1) (0 1 0)) for adjacent or 4-fold connectivity.

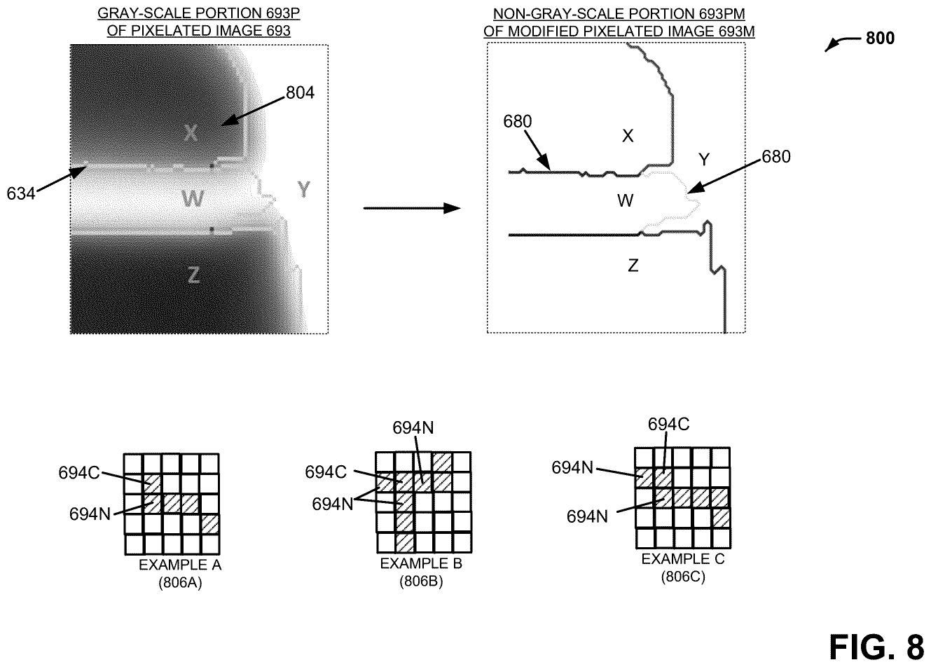

For example, turning now to FIG. 8, based on the mask having been applied by the convolving component 614, the classifying component 616 generally can parse a set of contour line pixels 694C that have been obtained by the identifying component 612. For example, a first section of the pixelated image 693 can be analyzed or an entire contour line 634 or a part thereof can be analyzed. At FIG. 8, a gray-scale portion 693P of the pixelated image 693 is illustrated, demonstrating at a high-level view where contour line pixels 694C and neighbor pixels 694N can be found in a pixelated image 693.

At the gray-scale portion 693P, it is noted that the image comprises various labeled sub-regions 804, labeled as W, X, Y and Z. These sub-regions 804 are labeled to illustrate a use of the non-limiting systems described herein. For example, the contour line 634 being referenced at FIG. 8 provides a barrier between various sub-regions including W, X and Y. It is noted that additional regions can be provided external to the region W-Y that are not illustrated in the partial pixelated image of FIG. 8. Absent use of the embodiments described herein, as a deficiency of existing frameworks, interfaces W-X and W-Y would be perceived and sub-processed based on a same contour line 634. As such, any post-processing refinement using the pixelated image 693 and contour line 634, output by an existing framework, would be performed based on same parameters being applied to the whole of the contour line 634 and the regions/sub-regions separated thereby. Indeed, using existing frameworks, no differentiation between the interfaces W-X and W-Y would be provided, identified, determined, calculated, evaluated, etc. Rather, only a single aggregated interface W-X/Y would be evaluated.

Differently, using the one or more embodiments described herein, the labeled contour line 634 can be subdivided into two or more different barrier lines 680. That is, put another way, an aggregated interface of W-X/Y can be subdivided, allowing for differentiation between the interfaces W-X and W-Y. For example, skipping briefly ahead only relative to the images, the non-gray-scale portion 693PM of a modified pixelated image 693M illustrates a pair of labeled boundary lines 680 that have been subdivided from the contour line 634 of the gray-scale portion 693P, using the one or more embodiments described herein.

Indeed, for accurate refinement of boundaries, different parameters instead should be applied to different interfaces of different materials. These different parameters can comprise, but are not limited to, pixel gray scale color and/or pixel intensity. For example, an interface W-X and an interface W-Y can have different parameters applied thereto. This can be facilitated by the one or more embodiments described herein, such as by subdividing the contour line 634 into a set of different barrier lines 680 using the one or more embodiments escribed herein. For example, a first barrier line 680 can be generated at the W-X interface, and a second barrier line 680 can be generated at the W-Y interface. To continue the previous discussion, these barrier lines 680 can be generated based on the contour line pixel 694C parsing.

That is, a set of contour line pixels 694C parsed by the classifying component 616 can be a list or any other format, such as, but not limited to, a graph, matrix, or any other data structure.

Based on an output of and/or using the mask, the classifying component 616 can parse the contour line pixels 694C and classify different contour line pixels 694C differently. In any such case, parsing can be employed to identify a number of neighbor pixels 694N that are disposed adjacent (e.g., contiguous with a side of) a contour line pixel 694C. In one or more embodiments, other contour line pixels 694N can be employed as neighbor pixels 694N. In one or more alternative embodiments, non-contour line pixels 694 of the regions 630 adjacent the contour lines 634 can be employed as neighbor pixels 694N.

Then, based on the parsing of the various contour line pixels 694C of the contour line 634, the classifying component 616 can generate a data structure 679 (e.g., any suitable data structure such as a list, matrix, graph, etc.) of data and/or metadata comprising and/or defining the data labels of the contour line pixels 694C as being path pixels, endpoint pixels or intersection pixels. Such data structure 679 can be stored internal to or external to the non-limiting system 600.

In a first case, the classifying component 616 can identify a contour line pixel 694C as being an end point pixel, to serve as an endpoint of a barrier line 680 to be subdivided from the contour line 634.

In one or more embodiments of the first case, where other contour line pixels 694C are employed as neighbor pixels 694N, such contour line pixel 694C can have only one neighbor pixel 694N associated therewith. See, for example the example A (806A) at FIG. 8, where the identified contour line pixel 694C has exactly one neighbor pixel 694N identified and disposed contiguous to the identified contour line pixel 694C.

In a second case, based on an output of and/or using the mask, a contour line pixel 694C can be classified by the classifying component 616 as an intersection pixel, to serve as an intersection of at least a pair of barrier lines 680 to be subdivided from the contour line 634. An intersection pixel can be an endpoint pixel or path pixel for more than one barrier line 680.

In one or more embodiments of the second case, where other contour line pixels 694C are employed as neighbor pixels 694N, this classification can be based on a respective contour line pixel 694C having three neighbor pixels 694N associated therewith. See, for example the example B (806B) at FIG. 8, where the identified contour line pixel 694C has three neighbor pixels 694N identified and disposed adjacent to the identified contour line pixel 694C.

More generally, these classifications of endpoint and intersection point can be based on each such respective contour line pixel 694C having other than two neighbor pixels 694N (in this case, contour line pixels) contiguous therewith.

In a third case, a contour line pixel 694C can be identified as a path pixel, by the classifying component 616. A path pixel can be within a barrier line 680, such as between endpoint pixels.

In one or more embodiments of the third case, where other contour line pixels 694C are employed as neighbor pixels 694N, there are exactly two neighbor pixels 694N associated with the contour line pixel 694C. See, for example the example C (806C) at FIG. 8, where the identified contour line pixel 694C has two neighbor pixels 694N identified and disposed contiguous with the identified contour line pixel 694C.

In a fourth case, where there are diagonally-connected contour lines 634 of a pixelated image 693, a second pixel (e.g., next from an endpoint pixel, such as a second pixel in a contour segment) can have multiple contiguous contour neighbor pixels 694N associated therewith. Such second pixel can be a midpoint pixel and/or an intersection pixel.

In one or embodiments of the fourth case, where other contour line pixels 694C are employed as neighbor pixels 694N, a second pixel can have three contiguous contour neighbor pixels 694N associated therewith.

Discussion now turns to alternative embodiments of the above-noted cases, where non-contour line pixels 694 are employed as neighbor pixels 694N.

In one or more alternative embodiments of the first case or second case, where non-contour line pixels 694 are employed as neighbor pixels 694N, a contour line pixel 694C having zero, one or three non-contour line pixels as neighbor pixels 694N would correlate to such contour line pixel 694C being classified as an endpoint or an intersection point.

In one or more alternative embodiments of the third case, where non-contour line pixels 694 are employed as neighbor pixels 694N, a contour line pixel 694C having exactly two non-contour line pixels as neighbor pixels 694N would correlate to such contour line pixel 694C being classified as a path pixel within a barrier line 680, such as between endpoint pixels.

In one or more alternative embodiments of the fourth case, where non-contour line pixels 694 are employed as neighbor pixels 694N, and where a pair of contour lines 634 is diagonally-connected, a contour line pixel 694C having seven, five or less than or equal to 4 such neighbor pixels 649N would correspond to the contour line pixel 694C being an endpoint or intersection, while the contour line pixel 694C having six or 5 such neighbor pixels 694N would correspond to the contour line pixel 694C being a midpoint or path pixel. It is noted that the case of the contour line pixel 694C having 5 neighbor pixels 694N associated therewith (still where non-contour line pixels 694 are employed as neighbor pixels 694N) can be classified as one or both of an endpoint/intersection pixel or midpoint/path pixel.

Discussion next turns to a set of steps of an algorithm that can be employed by the classifying component 616, based on the mask, and resulting in the generation of the data structure 679. It is noted that this set of steps is based on the base embodiment of neighbor pixels 694N being other contour line pixels 694C adjacent to (e.g., contiguous with) a contour line pixel 694C.

A first step can comprise adding all contour line pixels 694C to a data structure. Since this data structure 679 can become quite large and an be accessed frequently, it can be advantageous to employ a data structure that is an aggregation of groupings that takes advantage of the structure of the image to group the pixels.

A second step can comprise identifying all contour line pixels 694C that do not have exactly two neighbor pixels 694N associated therewith. These contour line pixels 694C can be added to a grouping of intersection/endpoint pixels of the data structure.

Any contour line pixel 694C with two neighbor pixels 694N associated therewith is along a path of a barrier line 680 and can be added to a grouping of path pixels of the data structure.

Any contour line pixel 694C having one neighbor pixel 694N associated therewith can be at the end of a barrier line 680 and thus be an endpoint pixel, which can be added to a grouping of endpoint pixels of the data structure.

For contour line pixels 694C with three or more neighbor pixels 694N associated therewith, add the number of neighbor pixels 694N, but minus one. This is because that pixel will be part of multiple paths, as an intersection pixel. An intersection pixel can be an endpoint pixel and/or a path pixel. For example, first barrier line can cross a second barrier line, and the intersection pixel can be a path pixel for both first and second barrier lines. Alternatively, a first barrier line can end at a non-endpoint portion of a second barrier line, and the intersection pixel can be a path pixel for the first barrier line but an endpoint pixel for the second barrier line. It is noted that the intersection can comprise more than two intersected barrier lines 680.

It is noted that above-described steps can be modified, alternatively based on the description above regarding non-contour line pixels 694 as neighbor pixels 694N, to employ such alternative embodiments of non-contour line pixels 694 as neighbor pixels 694N.

An optional step can comprise marking with metadata and/or removing a contour line pixel 694C from the data structure of the set of contour line pixels 694C after that contour line pixel 694C has been parsed.

A next step can comprise generating data to define barrier lines 680. That is, the subdividing component 620 can generally subdivide the analyzed contour line 634 into a set of barrier lines 680 based on a parsing of contour line pixels of the above steps.

The subdividing component 620 can begin with a first pixel in the endpoint grouping and follow that first pixel along a set of path pixels along the contour line 634 until a contour line pixel 634C identified as an endpoint pixel is reached. Once the end of a path is reached, that path can be added as a defined barrier line 680 to a path grouping. In one or more embodiments, pixels can be removed from the lists as they are found on a path. If an endpoint pixel serves as an endpoint pixel for two barrier liens 680/two paths, deletion of this pixel from an associated endpoint list is not detrimental, as the process will have continued or will next continue onto a next path of the contour line 634. This process can continue until all endpoints have been used. It is noted that an intersection pixel can be re-identified relative to another contour line analysis of a different contour line 634.

Finally, it can be noted that any remaining non-deleted/non-removed contour line pixels 694C can be part of one or more closed paths. Accordingly, to address the remaining contour line pixels 694C, the subdividing component 620 can start at the beginning of the contour line pixel grouping and trace the closed path until the start pixel is reached. Any closed paths can then be added to the path grouping.

When the contour pixel grouping is empty, path tracing is complete and the path grouping can be returned by the subdividing component 620, thereby providing a set of differentiated barrier lines 680 from a single contour line 634. As noted above, these paths form the boundaries between differentiated regions 630 and can be further refined in post-processing using edge detection such as edge finders.

Next, the iterating component 622 can determine whether there is an additional contour line 634 of the pixelated image 693 to be parsed by the classifying component 616 and subdivided by the subdividing component 620.

The generating component 624 generally can generate a modified pixelated image 693M highlighting the set of barrier lines 680 based on the contour line 634. For example, a first barrier line 680, of the set of barrier lines, can separate a first pair of materials of the sample 692, and a second barrier line 680, of the set of barrier lines, can separate a second pair of materials of the sample 692, where the second pair of materials can comprise at least one material being different from materials of the first pair of materials. For example, looking to FIG. 8, a non-gray-scale portion 693PM is illustrated as can be generated by the non-limiting system 600, by subdividing the contour line 634 into a set of two or more barrier lines 680. That is, non-gray-scale portion 693PM represents a portion of a modified pixelated image 693M.

Turning now to the illustration 900 of FIG. 9, the executing component 626 generally can perform one or more processes using the modified pixelated image 693M and the set of barrier lines 680.

In one or more embodiments, the executing component 626 can compare a first portion 904P of a barrier line, of the set of barrier lines of the pixelated image 693, to a corresponding second portion 904T of a corresponding second barrier line of a second pixelated image. In one or more embodiments, the first portion 904P can be of a known barrier line 680, while the second portion 904T can be of an unknown portion being compared to a baseline of the first portion 904P. The executing component 626 can employ pixel mapping to determine a pixel-based location difference of the second portion 904T as compared to the first portion 904P. That is, one or more barrier line pixels of the second portion 904T can be at different locations that do not exactly correspond to locations of the corresponding one or more barrier line pixels of the first portion 904P, and/or the second portion 904T can comprise more or less barrier line pixels than the first portion 904P.

In one or more other embodiments, the executing component 626 can direct revising of a portion 904P of a barrier line 680. For example, discussion turns briefly to FIG. 8 as a reference, and particularly to the non-gray-scale portion 694PM. Based on the generation of barrier lines 680 from the contour line 634, a location of a portion of a barrier line interface W-Y can be revised. For example, this revision can be based on one or more known techniques involving the use of pixel gray-scale level and/or pixel intensity, without being limited thereto. That is, with reference to FIG. 8, absent subdivision of the contour line 634 into the different interfaces provided by the barrier lines 680, this revision would not have been possible. That is, based on use of the one or more embodiments described herein, different interfaces W-X and W-Y can be delineated as different barrier lines 680, for which different revision parameters can be employed (e.g., for interface W-X as compared to interface W-Y).

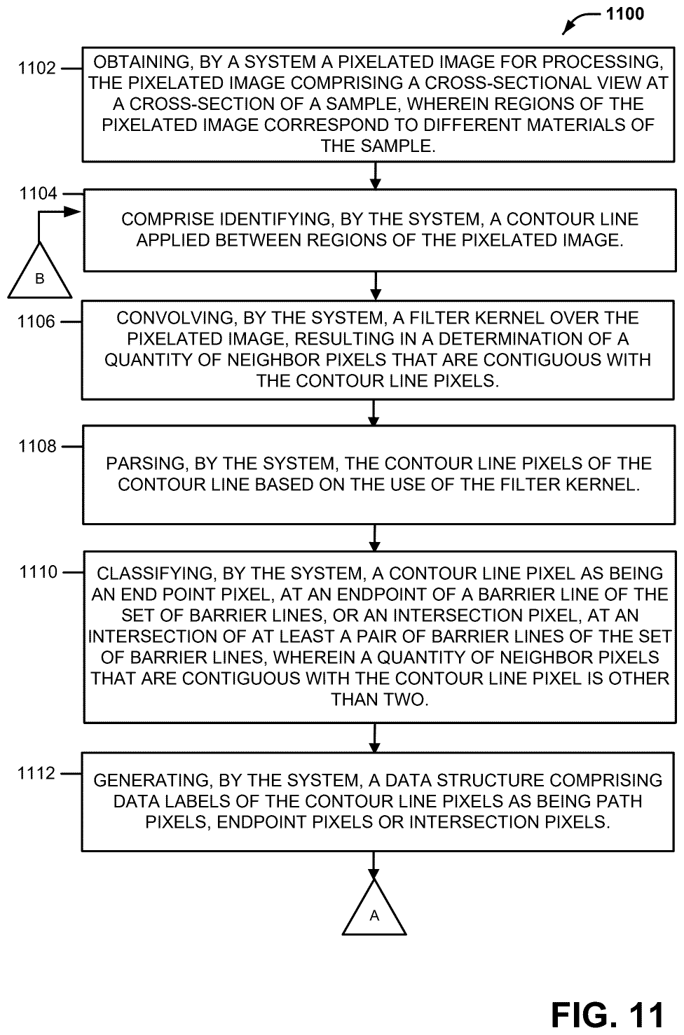

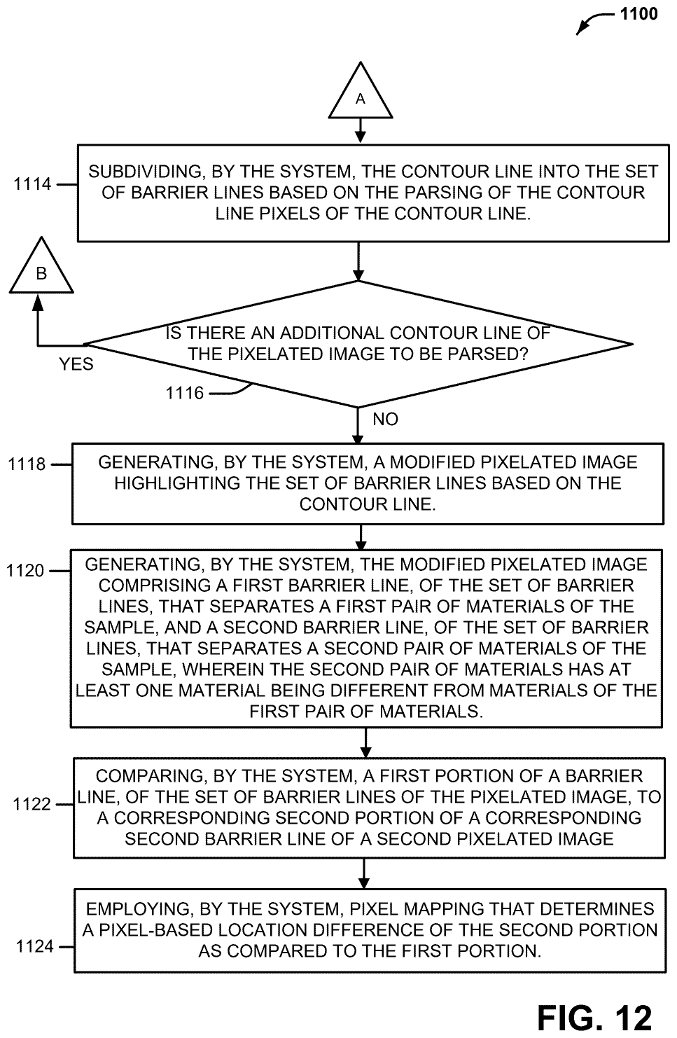

As a summary of the above-described components and functions thereof, referring next to FIGS. 11 and 12, illustrated is a flow diagram of an example, non-limiting method 1100 that can facilitate a process for contour line extraction of a pixelated image, in accordance with one or more embodiments described herein, such as the non-limiting system 600 of FIG. 6. While the non-limiting method 1100 is described relative to the non-limiting system 600 of FIG. 6, the non-limiting method 1100 can be applicable also to other systems described herein, such as the non-limiting system 500 of FIG. 5. Repetitive description of like elements and/or processes employed in respective embodiments is omitted for sake of brevity.

At 1102, the non-limiting method 1100 can comprise obtaining, by a system (e.g., obtaining component 610) a pixelated image (e.g., pixelated image 693) for processing, the pixelated image comprising a cross-sectional view at a cross-section of a sample (e.g., sample 692), wherein regions (e.g., regions 630) of the pixelated image correspond to different materials of the sample.

At 1104, the non-limiting method 1100 can comprise identifying, by the system (e.g., identifying component 612), a contour line (e.g., contour line 634) applied between regions of the pixelated image.

At 1106, the non-limiting method 1100 can comprise convolving, by the system (e.g., convolving component 614), a filter kernel over the pixelated image, resulting in a determination of a quantity of neighbor pixels that are contiguous with the contour line pixels (e.g., contour line pixels 69C or CL pixels 694C).

At 1108, the non-limiting method 1100 can comprise parsing, by the system (e.g., convolving component 616), the contour line pixels of the contour line based on the use of the filter kernel.

At 1110, the non-limiting method 1100 can comprise classifying, by the system (e.g., classifying component 616), a contour line pixel as being an end point pixel, at an endpoint of a barrier line (e.g., barrier line 680) of the set of barrier lines, or an intersection pixel, at an intersection of at least a pair of barrier lines of the set of barrier lines, wherein a quantity of neighbor pixels that are contiguous with the contour line pixel is other than two (e.g., neighbor pixels 694N or NBR pixels 694N).

At 1112, the non-limiting method 1100 can comprise generating, by the system (e.g., classifying component 616), a data structure comprising data labels of the contour line pixels as being path pixels, endpoint pixels or intersection pixels.

At 1114, the non-limiting method 1100 can comprise subdividing, by the system (e.g., subdividing component 620), the contour line into the set of barrier lines based on the parsing of the contour line pixels of the contour line.

At 1116, the non-limiting method 1100 can comprise determining, by the system (e.g., iterating component 622), whether there is an additional contour line of the pixelated image to be parsed. If yes, the non-limiting method 1100 can proceed back to step 1104. If not, the non-limiting method 1100 can proceed to step 1118.

At 1118, the non-limiting method 1100 can comprise generating, by the system (e.g., generating component 624), a modified pixelated image (e.g., modified pixelated image 693M) highlighting the set of barrier lines based on the contour line.

At 1120, the non-limiting method 1100 can comprise generating, by the system (e.g., generating component 624), the modified pixelated image comprising a first barrier line, of the set of barrier lines, that separates a first pair of materials (e.g., corresponding to sub-regions Y and Z at FIG. 8) of the sample, and a second barrier line, of the set of barrier lines, that separates a second pair of materials (e.g., corresponding to sub-regions W and X at FIG. 8) of the sample, wherein the second pair of materials has at least one material being different from materials of the first pair of materials.

At 1122, the non-limiting method 1100 can comprise comparing, by the system (e.g., executing component 626), a first portion of a barrier line (e.g., known portion 904P of a barrier line 680 at FIG. 9), of the set of barrier lines of the pixelated image, to a corresponding second portion of a corresponding second barrier line (e.g., test portion 904T of a barrier line 680T at FIG. 9) of a second pixelated image.

At 1124, the non-limiting method 1100 can comprise employing, by the system (e.g., executing component 626), pixel mapping that determines a pixel-based location difference of the second portion as compared to the first portion.

### ADDITIONAL SUMMARY

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, one or more systems, computer program products and/or computer-implemented methods provided herein relate to a process for image contour line extraction. A system can comprise a memory that stores, and a processor that executes, computer executable components. The computer executable components can comprise an identifying component that identifies a contour line applied between regions of a pixelated image; and a subdividing component that subdivides the contour line into a set of barrier lines based on a parsing of contour line pixels of the contour line.

The one or more embodiments described herein can be implemented within, in connection with and/or coupled to a scientific imaging device.

The one or more embodiments disclosed herein can achieve dynamic contour line extraction and subsequent modification, providing other than a one-size-fits-all approach. As used herein, the term dynamic can refer to the generation of different barrier lines for different material interfaces of a same contour line. That is, different initially-identified contour lines of a same image can have different thicknesses, be adjacent pixels of different material types, etc. To address these intricacies, the one or more embodiments described herein can provide for contour line extraction based on various iterations of determination of neighbor pixels using a dynamically-adjustable pixel threshold, to provide a dynamically-adjustable accuracy of the modification.

In this way, the one or more embodiments described herein can address different pixelation types (e.g., patternings, gray scale levels, etc.) of different materials allowing for the one or more embodiments described herein to be diversely applicable to a wide range of applications, materials, material types, etc. For example, different pixel thresholds can be employed for different materials or even different portions of a same sample being analyzed and for which contour line extraction is being sought.

The one or more embodiments described herein can provide for sub-pixel accuracy of contour line extraction based on these functions and abilities to iterate selected neighbor pixels (e.g., used to define a contour line extraction) until a dynamically-adjustable pixel threshold is satisfied.

The one or more embodiments described herein can be employed to analyze images comprising cross-sectional views of samples, rather than merely being applicable to overhead views and/or other external views, as with existing frameworks for contour line determination. Accordingly, the one or more embodiments described herein can have increased applicability for different purposes and industries, as compared to existing frameworks.

Indeed, in view of the one or more embodiments described herein, a practical application of the one or more systems, computer-implemented methods and/or computer program products described herein can be ability to provide contour line extraction relative to an image comprising regions of different materials of a sample, such as where the image comprises a cross-sectional view of the sample. Relative to the varying materials, extraction of contour lines adjacent and/or contiguous to these different material regions can be performed to allow for different parameters to be employed for different sections of a contour line when further refining positioning of the contour line. That is, as compared to existing frameworks that cannot provide this ability, the one or more embodiments described herein can provide a new result that was previously unavailable, e.g., provision of discrete barrier lines having endpoints, based on an initial generation of a contour line.

These are useful and practical applications of computers, thus providing enhanced (e.g., improved and/or optimized) material analysis and image modification output. Overall, such computerized tools can constitute a concrete and tangible technical improvement in the fields of material analysis, and more particularly in material analysis using contour line application techniques.

Furthermore, one or more embodiments described herein can be employed in a real-world system based on the disclosed teachings. For example, the one or more embodiments described herein can provide contour line extraction, allowing for determination of values (e.g., areas and/or other quantities) of regions bounded by a set of barrier lines subdivided from a contour line. This process can be operated relative to a single sample to obtain data defining the single sample. Additionally, and/or alternatively, this process can be employed to compare samples and/or to compare images to one another, thereby resulting in a determination of one or more similarities and/or one or more differences between the samples and/or images. These can be useful processes for varying industries employing material analysis, product manufacturing, quality control and/or the like. The embodiments disclosed herein thus can provide improvements to scientific instrument technology (e.g., improvements in the computer technology supporting such scientific instruments, among other improvements).

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to material analysis using contour line extraction, as compared to existing systems and/or techniques using holograms. Systems, computer-implemented methods and/or computer program products providing performance of these processes are of great utility in the fields of material analysis, such for determining quantities of materials of a sample based on the contour line extraction and/or for comparing samples based on contour line comparison between respective images of the samples and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively analyze computer data defining pixels of an image, analyze pixel data, digitally view and/or digitally illustrate an image at a sub-pixel level, transform pixel data into gray-scale levels and/or reorder and/or reclassify pixel data defining a contour line to adjust a location and/or shape of the contour line relative to adjacent sample-defining pixels as the one or more embodiments described herein can provide this process. Moreover, neither can the human mind nor a human with pen and paper conduct one or more of these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is next provided.

A system, comprising: a memory that stores computer executable components; and a processor that executes the computer executable components stored in the memory, wherein the computer executable components comprise: identifying component that identifies a contour line applied between regions of a pixelated image; and a subdividing component that subdivides the contour line into a set of barrier lines based on a parsing of contour line pixels of the contour line.

The system of the preceding paragraph, wherein the parsing is performed according to a quantity of neighbor pixels that are contiguous with the contour line pixels.

The system of any preceding paragraph, further comprising: a convolving component that convolves a filter kernel over the pixelated image, resulting in a determination of a quantity of neighbor pixels that are contiguous with the contour line pixels.

The system of any preceding paragraph, further comprising: a classifying component that classifies a contour line pixel as being an end point pixel, at an endpoint of a barrier line of the set of barrier lines, or an intersection pixel, at an intersection of at least a pair of barrier lines of the set of barrier lines, wherein a quantity of neighbor pixels that are contiguous with the contour line pixel is other than two.

The system of any preceding paragraph, further comprising: a classifying component that generates a data structure comprising data labels of the contour line pixels as being path pixels, endpoint pixels or intersection pixels.

The system of any preceding paragraph, further comprising: a generating component that generates a modified pixelated image highlighting the set of barrier lines based on the contour line, wherein a first barrier line, of the set of barrier lines, separates a first pair of materials of the sample, and wherein a second barrier line, of the set of barrier lines, separates a second pair of materials of the sample, the second pair of materials having at least one material being different from materials of the first pair of materials.

The system of any preceding paragraph, wherein the pixelated image comprises a cross-sectional view at a cross-section of a sample, and wherein the regions correspond to different materials of the sample.

The system of v, further comprising: an executing component that compares a first portion of a barrier line, of the set of barrier lines of the pixelated image, to a corresponding second portion of a corresponding second barrier line of a second pixelated image, wherein the executing component further employs pixel mapping that determines a pixel-based location difference of the second portion as compared to the first portion.

A computer-implemented method, comprising: subdividing, by a system operatively coupled to a processor, a contour line, applied between regions of a pixelated image, into a set of barrier lines; and generating, by the system, data employed for the subdividing by parsing contour line pixels, of the contour line.

The computer-implemented method of the preceding paragraph, further comprising: performing the parsing according to a quantity of neighbor pixels that are contiguous with the contour line pixels.

The computer-implemented method of any preceding paragraph, further comprising: convolving, by the system, a filter kernel over the pixelated image, resulting in a determination of a quantity of neighbor pixels that are contiguous with the contour line pixels.

The computer-implemented method of any preceding paragraph, further comprising: classifying, by the system, a contour line pixel as being an end point pixel, at an endpoint of a barrier line of the set of barrier lines, or an intersection pixel, at an intersection of at least a pair of barrier lines of the set of barrier lines, wherein a quantity of neighbor pixels that are contiguous with the contour line pixel is other than two.

The computer-implemented method of any preceding paragraph, further comprising: generating, by the system, a data structure comprising data labels of the contour line pixels as being path pixels, endpoint pixels or intersection pixels.

The computer-implemented method of any preceding paragraph, further comprising: generating, by the system, a modified pixelated image highlighting the set of barrier lines based on the contour line, wherein a first barrier line, of the set of barrier lines, separates a first pair of materials of the sample, and wherein a second barrier line, of the set of barrier lines, separates a second pair of materials of the sample, the second pair of materials having at least one material being different from materials of the first pair of materials.

The computer-implemented method of any preceding paragraph, wherein the pixelated image comprises a cross-sectional view at a cross-section of a sample, and wherein the regions correspond to different materials of the sample.

The computer-implemented method of any preceding paragraph, further comprising: comparing, by the system, a first portion of a barrier line, of the set of barrier lines of the pixelated image, to a corresponding second portion of a corresponding second barrier line of a second pixelated image; and employing, by the system, pixel mapping that determines a pixel-based location difference of the second portion as compared to the first portion.

A computer program product facilitating a process for image contour line extraction, the computer program product comprising a computer readable storage medium having program instructions embodied therewith, and the program instructions executable by a processor to cause the processor to: identify, by the processor, a set of contour lines applied between regions of a pixelated image; and subdivide, by the processor, the set of contour lines into a set of barrier lines based on a parsing of contour line pixels of the set of contour lines

The computer program product of the preceding paragraph, wherein the program instructions are further executable by the processor to cause the processor to: perform, by the processor, the parsing according to a quantity of neighbor pixels that are contiguous with the contour line pixels.

The computer program product of any preceding paragraph, wherein the program instructions are further executable by the processor to cause the processor to: convolve, by the processor, a filter kernel over the pixelated image, resulting in a determination of a quantity of neighbor pixels that are contiguous with the contour line pixels.

The computer program product of any preceding paragraph, wherein the program instructions are further executable by the processor to cause the processor to: classify, by the processor, a contour line pixel as being an end point pixel, at an endpoint of a barrier line of the set of barrier lines, or an intersection pixel, at an intersection of at least a pair of barrier lines of the set of barrier lines, wherein a quantity of neighbor pixels that are contiguous with the contour line pixel is other than two.

The computer program product of any preceding paragraph, wherein the pixelated image comprises a cross-sectional view at a cross-section of a sample, and wherein the regions correspond to different materials of the sample.

### Scientific Instrument System Description

Turning next to FIG. 13, a detailed description is provided of additional context for the one or more embodiments described herein at FIGS. 1-12. One or more computing devices implementing any of the scientific instrument modules or methods disclosed herein can be part of a scientific instrument system. FIG. 13 illustrates a block diagram of an example scientific instrument system 1300 in which one or more of the scientific instrument methods or other methods disclosed herein can be performed, in accordance with various embodiments described herein. The scientific instrument modules and methods disclosed herein (e.g., the scientific instrument module 100 of FIG. 1 and the method 200 of FIG. 2) can be implemented by one or more of the scientific instrument 1310, the user local computing device 1320, the service local computing device 1330, and/or the remote computing device 1340 of the scientific instrument system 1300.

Any of the scientific instrument 1310, the user local computing device 1320, the service local computing device 1330, and/or the remote computing device 1340 can include any of the embodiments of the computing device 400 discussed herein with reference to FIG. 4, and any of the scientific instrument 1310, the user local computing device 1320, the service local computing device 1330, and/or the remote computing device 1340 can take the form of any appropriate one or more of the embodiments of the computing device 400 discussed herein with reference to FIG. 4.

One or more of the scientific instrument 1310, the user local computing device 1320, the service local computing device 1330, and/or the remote computing device 1340 can include a processing device 1302, a storage device 1304, and/or an interface device 1306. The processing device 1302 can take any suitable form, including the form of any of the processors 402 discussed herein with reference to FIG. 4. The processing devices 1302 included in different ones of the scientific instrument 1310, the user local computing device 1320, the service local computing device 1330, and/or the remote computing device 1340 can take the same form or different forms. The storage device 1304 can take any suitable form, including the form of any of the storage devices 404 discussed herein with reference to FIG. 4. The storage devices 1304 included in different ones of the scientific instrument 1310, the user local computing device 1320, the service local computing device 1330, and/or the remote computing device 1340 can take the same form or different forms. The interface device 1306 can take any suitable form, including the form of any of the interface devices 406 discussed herein with reference to FIG. 4. The interface devices 1306 included in different ones of the scientific instrument 1310, the user local computing device 1320, the service local computing device 1330, and/or the remote computing device 1340 can take the same form or different forms.

The scientific instrument 1310, the user local computing device 1320, the service local computing device 1330, and/or the remote computing device 1340 can be in communication with other elements of the scientific instrument system 1300 via communication pathways 1308. The communication pathways 1308 can communicatively couple the interface devices 1306 of different ones of the elements of the scientific instrument system 1300, as shown, and can be wired or wireless communication pathways (e.g., in accordance with any of the communication techniques discussed herein with reference to the interface devices 406 of the computing device 400 of FIG. 4). The particular scientific instrument system 1300 depicted in FIG. 13 includes communication pathways between each pair of the scientific instrument 1310, the user local computing device 1320, the service local computing device 1330, and the remote computing device 1340, but this “fully connected” implementation is simply illustrative, and in various embodiments, various ones of the communication pathways 1308 can be omitted. For example, in one or more embodiments, a service local computing device 1330 can omit a direct communication pathway 1308 between its interface device 1306 and the interface device 1306 of the scientific instrument 1310, but can instead communicate with the scientific instrument 1310 via the communication pathway 1308 between the service local computing device 1330 and the user local computing device 1320 and/or the communication pathway 1308 between the user local computing device 1320 and the scientific instrument 1310.

The scientific instrument 1310 can include any appropriate scientific instrument, such as a separation or MS instrument, or other instrument facilitating material analysis.

The user local computing device 1320 can be a computing device (e.g., in accordance with any of the embodiments of the computing device 400 discussed herein) that is local to a user of the scientific instrument 1310. In one or more embodiments, the user local computing device 1320 can also be local to the scientific instrument 1310, but this need not be the case; for example, a user local computing device 1320 that is associated with a home, office or other building associated with a user entity can be remote from, but in communication with, the scientific instrument 1310 so that the user entity can use the user local computing device 1320 to control and/or access data from the scientific instrument 1310. In one or more embodiments, the user local computing device 1320 can be a laptop, smartphone, or tablet device. In one or more embodiments the user local computing device 1320 can be a portable computing device. In one or more embodiments, the user local computing device 1320 can deployed in the field.

The service local computing device 1330 can be a computing device (e.g., in accordance with any of the embodiments of the computing device 400 discussed herein) that is local to an entity that services the scientific instrument 1310. For example, the service local computing device 1330 can be local to a manufacturer of the scientific instrument 1310 or to a third-party service company. In one or more embodiments, the service local computing device 1330 can communicate with the scientific instrument 1310, the user local computing device 1320, and/or the remote computing device 1340 (e.g., via a direct communication pathway 1308 or via multiple “indirect” communication pathways 1308, as discussed above) to receive data regarding the operation of the scientific instrument 1310, the user local computing device 1320, and/or the remote computing device 1340 (e.g., the results of self-tests of the scientific instrument 1310, calibration coefficients used by the scientific instrument 1310, the measurements of sensors associated with the scientific instrument 1310, etc.). In one or more embodiments, the service local computing device 1330 can communicate with the scientific instrument 1310, the user local computing device 1320, and/or the remote computing device 1340 (e.g., via a direct communication pathway 1308 or via multiple “indirect” communication pathways 1308, as discussed above) to transmit data to the scientific instrument 1310, the user local computing device 1320, and/or the remote computing device 1340 (e.g., to update programmed instructions, such as firmware, in the scientific instrument 1310, to initiate the performance of test or calibration sequences in the scientific instrument 1310, to update programmed instructions, such as software, in the user local computing device 1320 or the remote computing device 1340, etc.). A user entity of the scientific instrument 1310 can utilize the scientific instrument 1310 or the user local computing device 1320 to communicate with the service local computing device 1330 to report a problem with the scientific instrument 1310 or the user local computing device 1320, to request a visit from a technician to improve the operation of the scientific instrument 1310, to order consumables or replacement parts associated with the scientific instrument 1310, or for other purposes.

The remote computing device 1340 can be a computing device (e.g., in accordance with any of the embodiments of the computing device 400 discussed herein) that is remote from the scientific instrument 1310 and/or from the user local computing device 1320. In one or more embodiments, the remote computing device 1340 can be included in a datacenter or other large-scale server environment. In one or more embodiments, the remote computing device 1340 can include network-attached storage (e.g., as part of the storage device 1304). The remote computing device 1340 can store data generated by the scientific instrument 1310, perform analyses of the data generated by the scientific instrument 1310 (e.g., in accordance with programmed instructions), facilitate communication between the user local computing device 1320 and the scientific instrument 1310, and/or facilitate communication between the service local computing device 1330 and the scientific instrument 1310.

In one or more embodiments, one or more of the elements of the scientific instrument system 1300 illustrated in FIG. 13 can be omitted. Further, in one or more embodiments, multiple ones of various ones of the elements of the scientific instrument system 1300 of FIG. 13 can be present. For example, a scientific instrument system 1300 can include multiple user local computing devices 1320 (e.g., different user local computing devices 1320 associated with different user entities or in different locations). In another example, a scientific instrument system 1300 can include multiple scientific instruments 1310, all in communication with service local computing device 1330 and/or a remote computing device 1340; in such an embodiment, the service local computing device 1330 can monitor these multiple scientific instruments 1310, and the service local computing device 1330 can cause updates or other information can be “broadcast” to multiple scientific instruments 1310 at the same time. Different ones of the scientific instruments 1310 in a scientific instrument system 1300 can be located close to one another (e.g., in the same room) or farther from one another (e.g., on different floors of a building, in different buildings, in different cities, etc.). In one or more embodiments, a scientific instrument 1310 can be connected to an Internet-of-Things (IoT) stack that allows for command and control of the scientific instrument 1310 through a web-based application, a virtual or augmented reality application, a mobile application, and/or a desktop application. Any of these applications can be accessed by a user entity operating the user local computing device 1320 in communication with the scientific instrument 1310 by the intervening remote computing device 1340. In one or more embodiments, a scientific instrument 1310 can be sold by the manufacturer along with one or more associated user local computing devices 1320 as part of a local scientific instrument computing unit 1312.

In one or more embodiments, different ones of the scientific instruments 1310 included in a scientific instrument system 1300 can be different types of scientific instruments 1310; for example, one scientific instrument 1310 can be an EDS device, while another scientific instrument 1310 can be an analysis device that analyzes results of an EDS device. In some such embodiments, the remote computing device 1340 and/or the user local computing device 1320 can combine data from different types of scientific instruments 1310 included in a scientific instrument system 1300.

### Example Operating Environment

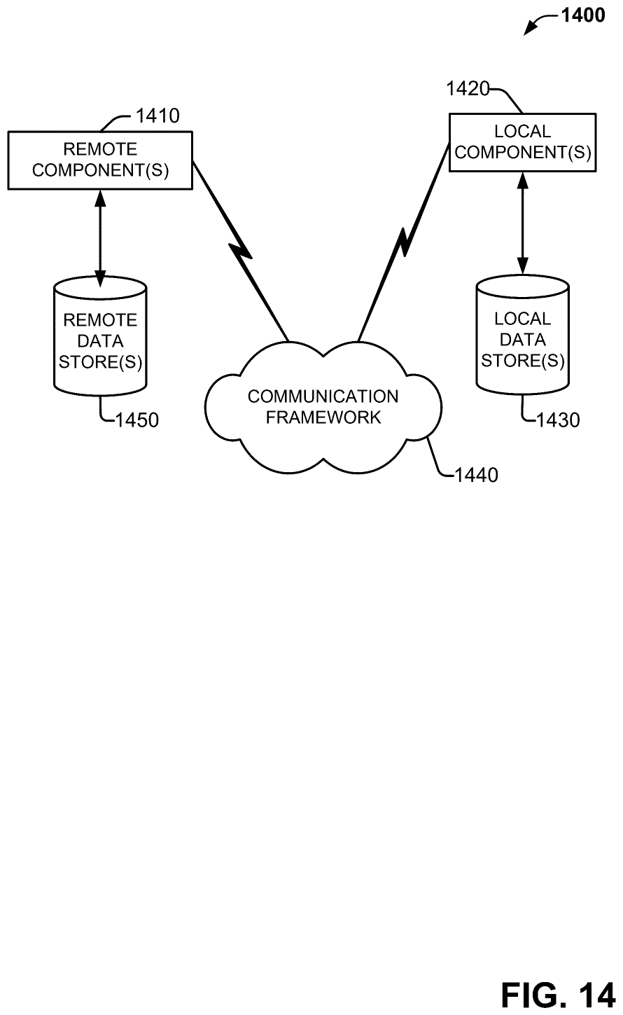

FIG. 14 is a schematic block diagram of an operating environment 1400 with which the described subject matter can interact. The operating environment 1400 comprises one or more remote component(s) 1410. The remote component(s) 1410 can be hardware and/or software (e.g., threads, processes, computing devices). In one or more embodiments, remote component(s) 1410 can be a distributed computer system, connected to a local automatic scaling component and/or programs that use the resources of a distributed computer system, via communication framework 1440. Communication framework 1440 can comprise wired network devices, wireless network devices, mobile devices, wearable devices, radio access network devices, gateway devices, femtocell devices, servers, etc.

The operating environment 1400 also comprises one or more local component(s) 1420. The local component(s) 1420 can be hardware and/or software (e.g., threads, processes, computing devices). In one or more embodiments, local component(s) 1420 can comprise an automatic scaling component and/or programs that communicate/use the remote resources 1410 and 1420, etc., connected to a remotely located distributed computing system via communication framework 1440.

One possible communication between a remote component(s) 1410 and a local component(s) 1420 can be in the form of a data packet adapted to be transmitted between two or more computer processes. Another possible communication between a remote component(s) 1410 and a local component(s) 1420 can be in the form of circuit-switched data adapted to be transmitted between two or more computer processes in radio time slots. The operating environment 1400 comprises a communication framework 1440 that can be employed to facilitate communications between the remote component(s) 1410 and the local component(s) 1420, and can comprise an air interface, e.g., interface of a UMTS network, via an LTE network, etc. Remote component(s) 1410 can be operably connected to one or more remote data store(s) 1450, such as a hard drive, solid state drive, subscriber identity module (SIM) card, electronic SIM (eSIM), device memory, etc., that can be employed to store information on the remote component(s) 1410 side of communication framework 1440. Similarly, local component(s) 1420 can be operably connected to one or more local data store(s) 1430, that can be employed to store information on the local component(s) 1420 side of communication framework 1440.

### Example Computing Environment

In order to provide additional context for various embodiments described herein, FIG. 15 and the following discussion are intended to provide a brief, general description of a suitable computing environment 1500 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform tasks or implement abstract data types. Moreover, the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring still to FIG. 15, the example computing environment 1500 which can implement one or more embodiments described herein includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi processor architectures can also be employed as the processing unit 1504.

The system bus 1508 can be any of several types of bus structure that can further interconnect to a memory bus (with or without a memory controller), a peripheral bus, and a local bus using any of a variety of commercially available bus architectures. The system memory 1506 includes ROM 1510 and RAM 1512. A basic input/output system (BIOS) can be stored in a non-volatile memory such as ROM, erasable programmable read only memory (EPROM), EEPROM, which BIOS contains the basic routines that help to transfer information between elements within the computer 1502, such as during startup. The RAM 1512 can also include a high-speed RAM such as static RAM for caching data.

The computer 1502 further includes an internal hard disk drive (HDD) 1514 (e.g., EIDE, SATA), and can include one or more external storage devices 1516 (e.g., a magnetic floppy disk drive (FDD) 1516, a memory stick or flash drive reader, a memory card reader, etc.). While the internal HDD 1514 is illustrated as located within the computer 1502, the internal HDD 1514 can also be configured for external use in a suitable chassis (not shown). Additionally, while not shown in computing environment 1500, a solid-state drive (SSD) could be used in addition to, or in place of, an HDD 1514.

Other internal or external storage can include at least one other storage device 1520 with storage media 1522 (e.g., a solid-state storage device, a nonvolatile memory device, and/or an optical disk drive that can read or write from removable media such as a CD-ROM disc, a DVD, a BD, etc.). The external storage 1516 can be facilitated by a network virtual machine. The HDD 1514, external storage device 1516 and storage device (e.g., drive) 1520 can be connected to the system bus 1508 by an HDD interface 1524, an external storage interface 1526 and a drive interface 1528, respectively.

The drives and their associated computer-readable storage media provide nonvolatile storage of data, data structures, computer-executable instructions, and so forth. For the computer 1502, the drives and storage media accommodate the storage of any data in a suitable digital format. Although the description of computer-readable storage media above refers to respective types of storage devices, other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. The systems and methods described herein can be implemented utilizing various commercially available operating systems or combinations of operating systems.

Computer 1502 can optionally comprise emulation technologies. For example, a hypervisor (not shown) or other intermediary can emulate a hardware environment for operating system 1530, and the emulated hardware can optionally be different from the hardware illustrated in FIG. 15. In such an embodiment, operating system 1530 can comprise one virtual machine (VM) of multiple VMs hosted at computer 1502. Furthermore, operating system 1530 can provide runtime environments, such as the Java runtime environment or the .NET framework, for applications 1532. Runtime environments are consistent execution environments that allow applications 1532 to run on any operating system that includes the runtime environment. Similarly, operating system 1530 can support containers, and applications 1532 can be in the form of containers, which are lightweight, standalone, executable packages of software that include, e.g., code, runtime, system tools, system libraries and settings for an application. Further, computer 1502 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1502, e.g., applied at the application execution level or at the operating system (OS) kernel level, thereby enabling security at any level of code execution.

A user entity can enter commands and information into the computer 1502 through one or more wired/wireless input devices, e.g., a keyboard 1538, a touch screen 1540, and a pointing device, such as a mouse 1542. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera, a gesture sensor input device, a vision movement sensor input device, an emotion or facial detection device, a biometric input device, e.g., fingerprint or iris scanner, or the like. These and other input devices are often connected to the processing unit 1504 through an input device interface 1544 that can be coupled to the system bus 1508, but can be connected by other interfaces, such as a parallel port, an IEEE 1394 serial port, a game port, a USB port, an IR interface, a BLUETOOTH® interface, etc.

A monitor 1546 or other type of display device can also be connected to the system bus 1508 via an interface, such as a video adapter 1548. In addition to the monitor 1546, a computer typically includes other peripheral output devices (not shown), such as speakers, printers, etc.

The computer 1502 can operate in a networked environment using logical connections via wired and/or wireless communications to one or more remote computers, such as a remote computer 1550. The remote computer 1550 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1552 is illustrated. The logical connections depicted include wired/wireless connectivity to a local area network (LAN) 1554 and/or larger networks, e.g., a wide area network (WAN) 1556. Such LAN and WAN networking environments are commonplace in offices and companies, and facilitate enterprise-wide computer networks, such as intranets, all of which can connect to a global communications network, e.g., the Internet.

When used in a LAN networking environment, the computer 1502 can be connected to the local network 1554 through a wired and/or wireless communication network interface or adapter 1558. The adapter 1558 can facilitate wired or wireless communication to the LAN 1554, which can also include a wireless access point (AP) disposed thereon for communicating with the adapter 1558 in a wireless mode.

When used in a WAN networking environment, the computer 1502 can include a modem 1560 or can be connected to a communications server on the WAN 1556 via other means for establishing communications over the WAN 1556, such as by way of the Internet. The modem 1560, which can be internal or external and a wired or wireless device, can be connected to the system bus 1508 via the input device interface 1544. In a networked environment, program modules depicted relative to the computer 1502 or portions thereof, can be stored in the remote memory/storage device 1552. The network connections shown are example and other means of establishing a communications link between the computers can be used.

When used in either a LAN or WAN networking environment, the computer 1502 can access cloud storage systems or other network-based storage systems in addition to, or in place of, external storage devices 1516 as described above. Generally, a connection between the computer 1502 and a cloud storage system can be established over a LAN 1554 or WAN 1556 e.g., by the adapter 1558 or modem 1560, respectively. Upon connecting the computer 1502 to an associated cloud storage system, the external storage interface 1526 can, with the aid of the adapter 1558 and/or modem 1560, manage storage provided by the cloud storage system as it would other types of external storage. For instance, the external storage interface 1526 can be configured to provide access to cloud storage sources as if those sources were physically connected to the computer 1502.

The computer 1502 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a defined structure as with an existing network or simply an ad hoc communication between at least two devices.

### ADDITIONAL INFORMATION

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments can use the phrases “an embodiment,” “various embodiments,” “one or more embodiments” and/or “some embodiments,” each of which can refer to one or more of the same or different embodiments.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an identifying component that identifies a contour line applied between regions of a pixelated image; and
a subdividing component that subdivides the contour line into a set of barrier lines based on a parsing of contour line pixels of the contour line.

2. The system of claim 1, wherein the parsing is performed according to a quantity of neighbor pixels that are contiguous with the contour line pixels.

3. The system of claim 1, further comprising:
a convolving component that convolves a filter kernel over the pixelated image, resulting in a determination of a quantity of neighbor pixels that are contiguous with the contour line pixels.

4. The system of claim 1, further comprising:
a classifying component that classifies a contour line pixel as being an end point pixel, at an endpoint of a barrier line of the set of barrier lines, or an intersection pixel, at an intersection of at least a pair of barrier lines of the set of barrier lines,
wherein a quantity of neighbor pixels that are contiguous with the contour line pixel is other than two.

5. The system of claim 1, further comprising:
a classifying component that generates a data structure comprising data labels of the contour line pixels as being path pixels, endpoint pixels or intersection pixels.

6. The system of claim 1, further comprising:
a generating component that generates a modified pixelated image highlighting the set of barrier lines based on the contour line,
wherein a first barrier line, of the set of barrier lines, separates a first pair of materials of the sample, and
wherein a second barrier line, of the set of barrier lines, separates a second pair of materials of the sample, the second pair of materials having at least one material being different from materials of the first pair of materials.

7. The system of claim 1, wherein the pixelated image comprises a cross-sectional view at a cross-section of a sample, and wherein the regions correspond to different materials of the sample.

8. The system of claim 1, further comprising:
an executing component that compares a first portion of a barrier line, of the set of barrier lines of the pixelated image, to a corresponding second portion of a corresponding second barrier line of a second pixelated image,
wherein the executing component further employs pixel mapping that determines a pixel-based location difference of the second portion as compared to the first portion.

9. A computer-implemented method, comprising:
subdividing, by a system operatively coupled to a processor, a contour line, applied between regions of a pixelated image, into a set of barrier lines; and
generating, by the system, data employed for the subdividing by parsing contour line pixels, of the contour line.

10. The computer-implemented method of claim 9, further comprising:
performing the parsing according to a quantity of neighbor pixels that are contiguous with the contour line pixels.

11. The computer-implemented method of claim 9, further comprising:
convolving, by the system, a filter kernel over the pixelated image, resulting in a determination of a quantity of neighbor pixels that are contiguous with the contour line pixels.

12. The computer-implemented method of claim 9, further comprising:
classifying, by the system, a contour line pixel as being an end point pixel, at an endpoint of a barrier line of the set of barrier lines, or an intersection pixel, at an intersection of at least a pair of barrier lines of the set of barrier lines,
wherein a quantity of neighbor pixels that are contiguous with the contour line pixel is other than two.

13. The computer-implemented method of claim 9, further comprising:
generating, by the system, a data structure comprising data labels of the contour line pixels as being path pixels, endpoint pixels or intersection pixels.

14. The computer-implemented method of claim 9, further comprising:
generating, by the system, a modified pixelated image highlighting the set of barrier lines based on the contour line,
wherein a first barrier line, of the set of barrier lines, separates a first pair of materials of the sample, and
wherein a second barrier line, of the set of barrier lines, separates a second pair of materials of the sample, the second pair of materials having at least one material being different from materials of the first pair of materials.

15. The computer-implemented method of claim 9, wherein the pixelated image comprises a cross-sectional view at a cross-section of a sample, and wherein the regions correspond to different materials of the sample.

16. The computer-implemented method of claim 9, further comprising:
comparing, by the system, a first portion of a barrier line, of the set of barrier lines of the pixelated image, to a corresponding second portion of a corresponding second barrier line of a second pixelated image; and
employing, by the system, pixel mapping that determines a pixel-based location difference of the second portion as compared to the first portion.

17. A computer program product facilitating a process for image contour line extraction, the computer program product comprising a computer readable storage medium having program instructions embodied therewith, and the program instructions executable by a processor to cause the processor to:
identify, by the processor, a set of contour lines applied between regions of a pixelated image; and
subdivide, by the processor, the set of contour lines into a set of barrier lines based on a parsing of contour line pixels of the set of contour lines.

18. The computer program product of claim 17, wherein the program instructions are further executable by the processor to cause the processor to:
perform, by the processor, the parsing according to a quantity of neighbor pixels that are contiguous with the contour line pixels.

19. The computer program product of claim 17, wherein the program instructions are further executable by the processor to cause the processor to:
convolve, by the processor, a filter kernel over the pixelated image, resulting in a determination of a quantity of neighbor pixels that are contiguous with the contour line pixels.

20. The computer program product of claim 17, wherein the program instructions are further executable by the processor to cause the processor to:
classify, by the processor, a contour line pixel as being an end point pixel, at an endpoint of a barrier line of the set of barrier lines, or an intersection pixel, at an intersection of at least a pair of barrier lines of the set of barrier lines,
wherein a quantity of neighbor pixels that are contiguous with the contour line pixel is other than two.
